(19) United States
(12) Patent Application Publication
(10) Pub. No.: US 2013/0054678 A1
(43) Pub. Date: Feb. 28, 2013

(54) DATA COLLECTION FORM AUTHORING SYSTEM WITH REMOTE CLIENT DATA COLLECTION AND MANAGEMENT SYSTEM

(71) Applicants: David Kevin Williams, Gainesville, FL (US); Andriy Oleksandrovich Selyutin, Gainesville, FL (US); James Arthur Davis, JR., Gainesville, FL (US)

(72) Inventors: David Kevin Williams, Gainesville, FL (US); Andriy Oleksandrovich Selyutin, Gainesville, FL (US); James Arthur Davis, JR., Gainesville, FL (US)

(21) Appl. No.: 13/399,617

(22) Filed: Feb. 17, 2012

Related U.S. Application Data
(60) Provisional application No. 61/444,788, filed on Feb. 20, 2011.
(60) Provisional application No. 61/521,326, filed on Aug. 8, 2011.

(51) Int. Cl. G06F 15/16

(52) U.S. Cl. 709/203

(57) ABSTRACT

Systems, apparatuses, and methods are provided for authoring data collection devices, deploying data collection devices for the collection of data, retrieving data collection devices and collected data, and/or managing collected data and relationships between data collectors and data providers. Client data is collected from a client remotely via any network-enabled input device and retrieved by a service provider prior to an encounter between the client and the service provider. Client data is collected preferably through deployment of client data collection forms authored by service providers by means of a form creation system in which specialty specific data containers stored in one or more libraries are arranged via a drag-and-drop interface to establish a form. Client data can be configured for passage to third party data storage and/or processing systems. Clients can be referred to other service providers with data being pre-populated into the other service providers' data collection forms.

### CROSS REFERENCE TO RELATED APPLICATIONS

The present application claims priority from U.S. Provisional Application No. 61/444,788 filed Feb. 20, 2011 and U.S. Provisional Application No. 61/521,326 filed Aug. 8, 2011, the entire disclosures of which are hereby incorporated by reference herein.

### FIELD OF THE INVENTION

The present invention relates to systems and methods for service provider remote collection and management of client data.

### BACKGROUND OF THE INVENTION

Existing systems and methods used by service providers for the collection and management of client data have shortcomings.

During a client's initial visit to a service provider's office, the office personnel may present to the client several pages of physical paper registration forms that the client must complete prior to meeting with the service provider. Such forms may require information that the client is unable to recall, and/or information from documentation the client neglected to bring to the office.

For example, in the medical industry, when a client such as, for example, a patient, seeks an appointment with a service provider such as, for example, a physician, the patient may be requested to record on a registration form a medical history, a list of medications, and insurance coverage details. Often, the patient is unable to recall the requested information accurately, and/or has neglected to bring documentation that contains the requested information.

As a result, inaccurate and/or inconsistent information may be recorded in the client's record, and/or the client's appointment, and/or other clients' appointments, may be delayed. Some existing systems and methods seek to address these issues by enabling clients to complete registration forms prior to visiting service providers. For example, it is not uncommon for a physician's office to enable a patient to download a registration form from the physician's practice's website, and expect the patient to complete the form at home and bring the completed form to the office at the time of the appointment. However, such approaches remain time consuming and effort intensive for clients, and do little to reduce the likelihood of inaccuracies and inconsistencies. Inaccuracies and inconsistencies in client data can lead to less effective provision of services. For example, diagnoses of patient conditions or ailments may be incomplete or incorrect, preventing physicians from effectively diagnosing and/or treating the patient.

Further, when the client visits another service provider, as a result of referral or otherwise, the client may be required to complete a new set of nearly identical registration forms. For example, when the patient visits another physician, such as, for example, a specialist to whom the patient has been referred by the original physician or, for example, a physician the patient desires to visit for a second opinion or as a result of another medical concern, the patient may be required to complete registration forms for the other physician's office, and those forms may request similar information, at least in part.

The process of providing the information again is time consuming and frustrating for the client under stressful circumstances. The duplication of paperwork generates higher administrative costs for every physician's office, resulting in an overall increase in healthcare costs.

In attempts to address these and other shortcomings of existing systems and methods, electronic record systems and client management systems have been developed. However, such devices are either not directly available to service providers, or are so available only in a limited capacity with respect to client registration and without functionality that enables service providers to create or customize client data collection forms.

In the medical industry, the various electronic medical records systems (EMRs), personal health records systems (PHRs) and patient management systems (PMSs) that have been developed share these shortcomings. As a result, in hospitals and other multi-physician organizations, all physicians must use the same form, regardless of practice specialty. For example, a cardiologist must use the same form as a neurologist, and a neurologist must use the same form as an obstetrician/gynecologist. Patient data required by the latter for proper treatment is in stark contrast to patient data required by the former.

In addition in the medical industry, the various EMRs, PHRs, and PMSs that have been developed use methodologies for recording and storing collected data that inhibit interoperability among such systems and inhibit interoperability in accordance with industry standard frameworks. As an example, such systems are unable to assign to patient related data, at the time of collection, standard clinical nomenclature codes that are required for interoperability with industry standard frameworks for storage, transmission, and processing.

Further in the medical industry, a significant percentage of insurance coverage, co-payment, and deductible information submitted to insurance companies is deemed incorrect. Such incorrect submissions create a draw on office staff time, may cost health care providers money that the health care providers had planned on receiving from patients, and/or may delay the processing of insurance claims. Health care providers often will not resubmit these claims, which results in a direct loss of revenue. If health care providers were to receive more complete and accurate insurance information prior to a patient's appointment date, office staff could verify insurance eligibility and/or correct discrepancies prior to the initial submission of claims, which would likely result in cost savings.

### SUMMARY OF THE INVENTION

Accordingly, one or more aspects of the present invention include providing systems and methods that enable service providers to establish, modify, and deploy specialty specific client data collection forms, to collect client data using such forms, and to store and manage such forms and such collected client data, such that interoperability with industry standard frameworks for storage, transmission, and processing is maintained. Further accordingly, additional aspects of the present invention include providing systems and methods that help to increase the completeness and accuracy of client information collected by and transmitted among service providers and related parties, and specifically but not limited to insurance information collected by and transmitted among health care providers and related parties in the medical industry.

Systems, apparatuses, and methods are provided for a network-based (for example, Internet-based, web-based, and/or intranet-based) client data collection system preferably by which client data is collected from a client (for example, a health care patient) remotely via any network-enabled (for example, Internet-enabled, web-enabled, and/or intranet-enabled) input device and retrieved by a service provider (for example, a health care provider) prior to an encounter between the client and the service provider (for example, a health care appointment between a patient and a health care provider, including, for example, a point of care).

Client data is collected preferably through utilization of custom client data collection forms that have been created by means of a system (preferably, for example, a drag-and-drop system) in which data containers (for example, relational data collection fields) are stored in a data container library (for example, a field library) and selectively grouped together into data sections (for example, data collection blocks) which are then, or have been, stored in a data section library (for example, a block library), and which are then arranged within forms by the data collection forms' author(s) (preferably, for example, via the aforementioned drag-and-drop system).

This form creation system preferably automatically and/or simultaneously (1) creates a client-facing form (for example, an HTML-based form and/or interface) that a client uses to input the client's information, and/or (2) creates respective database(s) where the collected data will be stored along with (a) instructions for pre-population of information in related fields (referred to as “mapping of data” between data collection fields) within the form and/or between any subsequent forms completed by the client and/or other clients, (b) instructions for automatic assignment of appropriate codes (for example, clinical nomenclature codes), and/or (c) an automatic form (for example, a PDF form) by which collected data will be presented when the data is retrieved by the end user.

The system also preferably enables a non-client user such as a service provider (for example, a health care provider) to (1) schedule an encounter (for example, a health care appointment) between the service provider and a client (for example, a health care patient), (2) send to the client by electronic message (for example, electronic mail, SMS text, and/or phone message) (a) reminders of the time of the scheduled encounter and/or (b) a map of and/or directions to the encounter location, (3) verify the client's insurance coverage and eligibility (if applicable, such as, for example, for a patient of a health care provider), (4) export the client's data to a third-party data storage and/or management system, and/or (5) electronically refer the client to another service provider by transmitting any pertinent data to the receiving service provider. The system also preferably enables a service provider and/or a group of service providers to electronically communicate and/or transmit client data to one another within a secure environment provided by the management system.

In at least one embodiment, disclosed is a system, apparatus, and/or method whereby client data collection forms can be created preferably via a drag-and-drop system from one or more libraries of related, specialty-specific data collection fields. Preferably, such a system has one or more of the following features: (1) during form creation, the system automatically and/or simultaneously creates the client-facing HTML data collection interface; (2) automatic and simultaneous mapping of data between data collection fields occurs within any form; (3) the automatic and/or simultaneous assignment of appropriate numerical codes (for example, clinical nomenclature codes) to each data point collected occurs; (4) a human readable document containing the inputted data is automatically and/or simultaneously created; and/or (5) an automatically and/or simultaneously generated document is a PDF.

Also preferably, in at least one embodiment, disclosed is a system, apparatus, and/or method whereby a client can remotely enter client data using a web-enabled device via a secure, encrypted electronic session accessed by clicking a link to a secure website portal. Preferably, such a system has one or more of the following features: (1) a client can input information by assigning conditions to individual selections of an animated and interactive digital rendering of various representations (for example, anatomical representations); (2) the assigned conditions are assigned a coded numerical value relative to a database of coded nomenclatures (for example, scientific nomenclatures); and (3) the portal is on a website, in an electronic mail message, and/or in an SMS text message.

Also preferably, in at least one embodiment, disclosed is a system, apparatus, and/or method for scheduling a client encounter, whereby time-specific reminders to a client can be established. Preferably, such a system has one or more of the following features: (1) time-specific reminders can be sent to a client via an electronic mail message and/or SMS text message; and (2) time-specific reminders are bi-directional, such that the recipient (for example, client) can communicate with the sender (for example, service provider), including, for example, to indicate a desire to cancel, confirm, and/or reschedule a scheduled encounter.

Also preferably, in at least one embodiment, disclosed is a system, apparatus, and/or method for scheduling a client encounter, whereby the client receives a map and/or directions via a link in an electronic mail message and/or SMS text message.

Also preferably, in at least one embodiment, disclosed is a system, apparatus, and/or method for scheduling a client encounter, whereby a client's insurance coverage and eligibility information is automatically verified at both the point of submission by a client and at any instance of retrieval by a provider. Preferably, such a system has the following feature: The insurance coverage verification information can be outputted in the form of a PDF.

Also preferably, in at least one embodiment, disclosed is a system, apparatus, and/or method whereby a client's coded or un-coded data can be passed to a third party data storage and/or processing system via one or more of (1) an Application Programming Interface (API), (2) a Health Level Seven International (HL7) interface, (3) a document formatted in a Comma Separated Values (CSV) format, (4) a document formatted in a customized Extensible Markup Language (XML) format, (5) a Continuity of Care Document (CCD), and/or (6) a Continuity of Care Record (CCR) using the CCR standard.

Also preferably, in at least one embodiment, disclosed is a system, apparatus, and/or method whereby a client can be referred to another service provider by means of electronically transmitting the client's data to the receiving service provider within a secure and encrypted environment and the client's previously entered data is pre-populated into the new service provider's data collection form.

Also preferably, in at least one embodiment, disclosed is a system, apparatus, and/or method that allows electronically connected providers to pass client-related data and documents via a secure electronic messaging environment.

Also preferably, in at least one embodiment, disclosed is a system, apparatus, and/or method that is the result of vertically integrating all the above-described systems, apparatuses, and/or methods to create a client registration and management system.

### BRIEF DESCRIPTION OF THE DRAWINGS

FIG. 1 illustrates an example of a host server in accordance with one or more aspects of the invention.

FIG. 2 illustrates an example of a host server storage unit of a host server in accordance with one or more aspects of the invention.

FIGS. 3-6 illustrate examples of a field library, a block library, a page library, and a form library of a host server storage unit of a host server in accordance with one or more aspects of the invention.

FIGS. 7-11 illustrate an example of an authoring software program in accordance with one or more aspects of the invention.

FIG. 12 illustrates an example of a client management software program in accordance with one or more aspects of the invention.

FIG. 13 illustrates an example of a client registration software program in accordance with one or more aspects of the invention.

FIGS. 14-17 illustrate examples of registration solicitation functionality of a client registration software program in accordance with one or more aspects of the invention.

FIGS. 18-19 illustrate an example of registration functionality of a client registration software program in accordance with one or more aspects of the invention.

FIG. 20 illustrates an example of registration notification functionality of a client registration software program in accordance with one or more aspects of the invention.

FIG. 21 illustrates an example of insurance verification functionality of a client registration software program in accordance with one or more aspects of the invention.

FIG. 22 illustrates an example of PDF formatted registration form functionality of a client registration software program in accordance with one or more aspects of the invention.

FIG. 23 illustrates an example of post registration map presentation functionality of a client registration software program in accordance with one or more aspects of the invention.

FIGS. 24-26 illustrate an example of client registration retrieval functionality of a client management software program in accordance with one or more aspects of the invention.

FIG. 27 illustrates an example of client registration PDF format saving and printing functionality of a client management software program in accordance with one or more aspects of the invention.

FIG. 28 illustrates an example of client registration specialized format saving functionality of a client management software program in accordance with one or more aspects of the invention.

FIG. 29 illustrates an example of client registration insurance verification functionality of a client management software program in accordance with one or more aspects of the invention.

FIG. 30 illustrates an example of client referral functionality of a client management software program in accordance with one or more aspects of the invention.

FIGS. 31-33 illustrate an example of service provider subscription functionality of a service provider subscription program in accordance with one or more aspects of the invention.

FIG. 34 illustrates an example of service provider account setup functionality of a service provider subscription program in accordance with one or more aspects of the invention.

FIGS. 35-38 illustrate an example of service provider account management functionality of a service provider subscription program in accordance with one or more aspects of the invention.

FIG. 39 illustrates an example of service provider client referral management functionality of a service provider subscription program in accordance with one or more aspects of the invention.

### DETAILED DESCRIPTION OF THE INVENTION

Preferred embodiments of the present invention will now be described in detail.

Embodiments of the present invention preferably include one or more systems, apparatuses, and/or methods for authoring data collection devices, deploying data collection devices for the collection of data, retrieving data collection devices and collected data, and/or managing collected data and relationships between data collectors and data providers.

For example purposes only, the present invention is described with reference to service providers as data collectors, and clients as data providers.

Non-limiting examples of service providers include health care professionals (for example, physicians, therapists, nurse practitioners, and the like), health care institutions (for example, hospitals, physician practices, medical centers, wellness centers, pharmacies, cruise ships with on-board infirmaries, medical military installations, and the like), legal professionals and related institutions (for example, lawyers, law firms, and the like), financial professionals and related institutions (for example, accountants, accounting firms, brokers, brokerage firms, banks, and the like), real estate professionals and related institutions (for example, realtors, realtors' offices, and the like), education professionals and related institutions (for example, teachers, professors, lecturers, schools, colleges, universities, continuing education institutions, learning institutions, and the like), consultants, contractors, hospitality related personnel and institutions (for example, hotels, conference organizers, vacation managers, and the like), entertainment providers and related institutions, and any other provider of services or potential provider of services that desires to collect data from clients and potential clients.

Examples of clients include clients of service providers and potential clients of service providers.

Accordingly, as used herein, the term “service provider” shall include any provider of any service, any potential provider of any service, and any person, representative, agent, or entity operating on behalf of a service provider. Further accordingly, as used herein, the term “client” shall include any client of any service provider, any potential client of any service provider, and any person, representative, agent, or entity operating on behalf of any client.

Embodiments of the present invention can be employed, for example, in or in connection with any company or institution that desires to collect client data in order to, for example, provide to the client, or other data-entering individual or group, a service.

The functionalities described herein are preferably accomplished by one or more engines (such engines preferably including software running on at least one computer machine with a processor, memory, data storage capability, and networking capability, and preferably on two or more such computer machines communicating over a network such as, for example, the Internet), and preferably accomplished remotely, that is, over a network such as, for example, the Internet, an intranet, a wide area network, a local area network, and/or other network, through the operation of machines communicating with one another over the network, such as, for example, computers, tablets, smartphones, appliances, or any other network-enabled device. Further preferably, transmissions and storage employed by the present invention are accomplished with secure transmission and storage protocols and using encryption and decryption protocols.

It should be understood that one or more features and/or systems of the present invention preferably can be integrated with client management systems, electronic record systems, personal record systems, billing systems, financial systems, appointment systems, scheduling systems, messaging systems, and/or other systems, including but not limited to third party systems owned, operated, and/or maintained by clients and/or service providers, and that any of such features and/or systems of the present invention can be applied to wholly replace and/or supplement in one or more aspects systems with which such features and/or systems of the present invention are integrated. For example, if a service provider does not currently use a client management system, appointment system, scheduling system, or messaging system, the client management, appointment, scheduling, and messaging systems of the present invention preferably can be made available to the service provider. Or, for example, if a service provider does currently use a client management system, appointment system, scheduling system, or messaging system, but the service provider's client management system lacks certain features that are part of the present invention, such features of the present invention preferably can be made available to the service provider in a manner that integrates with the service provider's systems. Examples of features of such integration made possible by the present invention include, but are not limited to, the systems of the present invention pushing data to and/or activating a client's and/or service provider's systems, and/or the client's and/or service provider's systems pushing data to and/or activating features of the present invention. Further, it should be understood that one or more features and/or systems of the present invention preferably can be offered using a software as a service (for example, SAAS model), whereby, for example, one or more features and/or systems of the present invention are maintained, managed, and otherwise operated by a host company, and accessed (and/or otherwise used) by clients and/or service providers without requiring such features and/or systems to reside on machines (or other devices) owned and/or maintained by such clients and/or service providers.

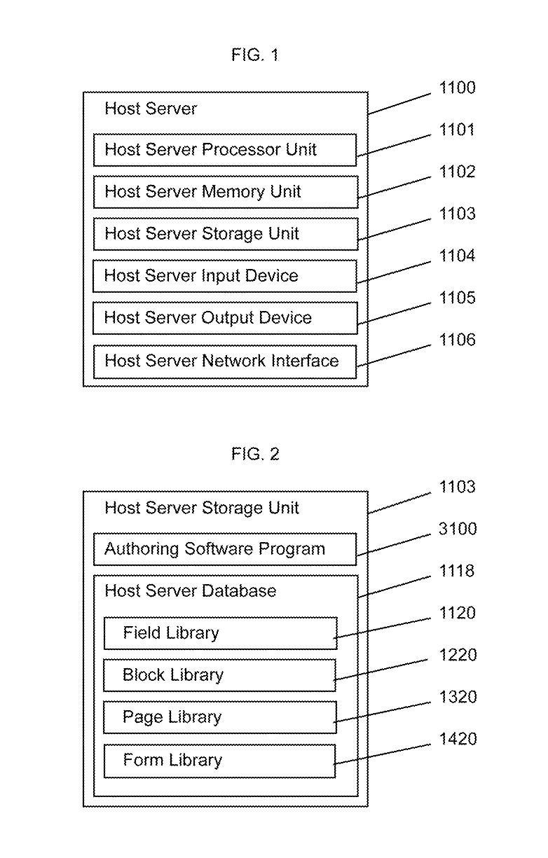

Accordingly, and referring now to FIG. 1, a system of the present invention preferably includes a host server 1100. The host server 1100 preferably includes a host server processor unit 1101, a host server memory unit 1102, a host server storage unit 1103, a host server input device 1104, a host server output device 1105, and a host server network interface 1106.

Further, the present invention preferably includes systems, apparatuses, methods, and/or other means for enabling customized authoring, by, for example, service providers, of data collection devices, such as, for example, data collection forms such as, for example, registration forms, and/or for defining and/or having defined at least one, and preferably all, operational parameters of such forms.

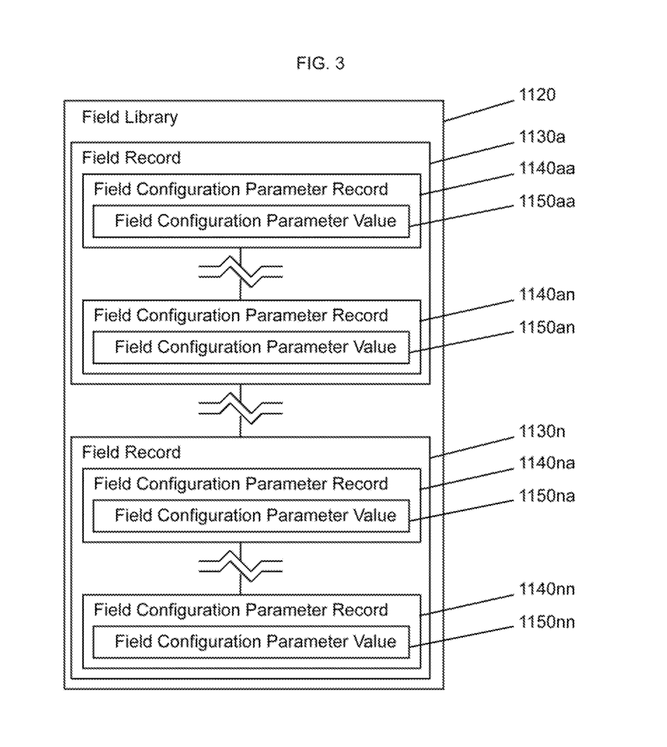

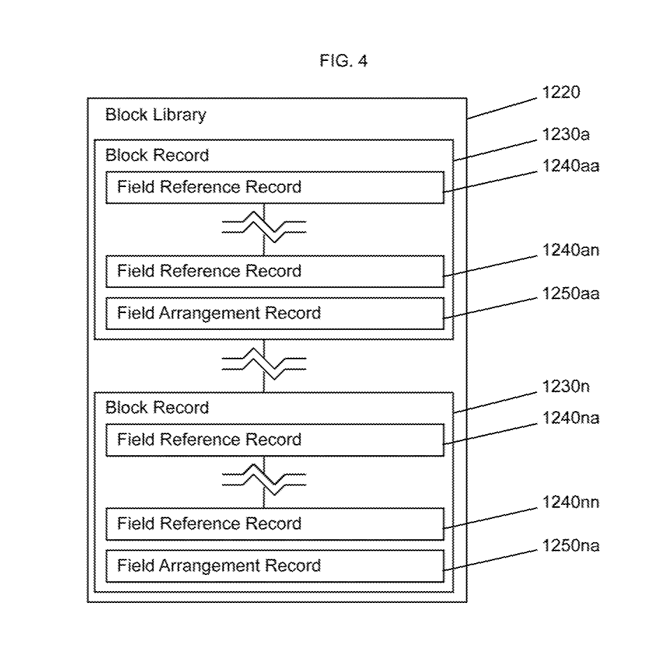

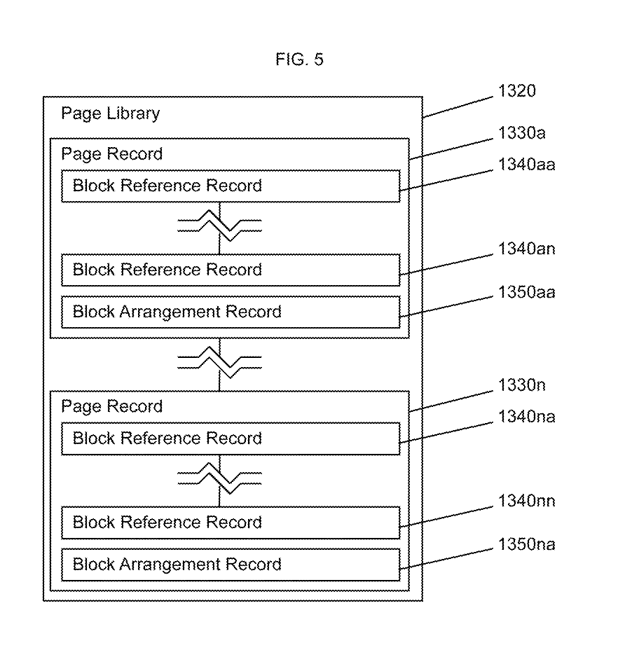

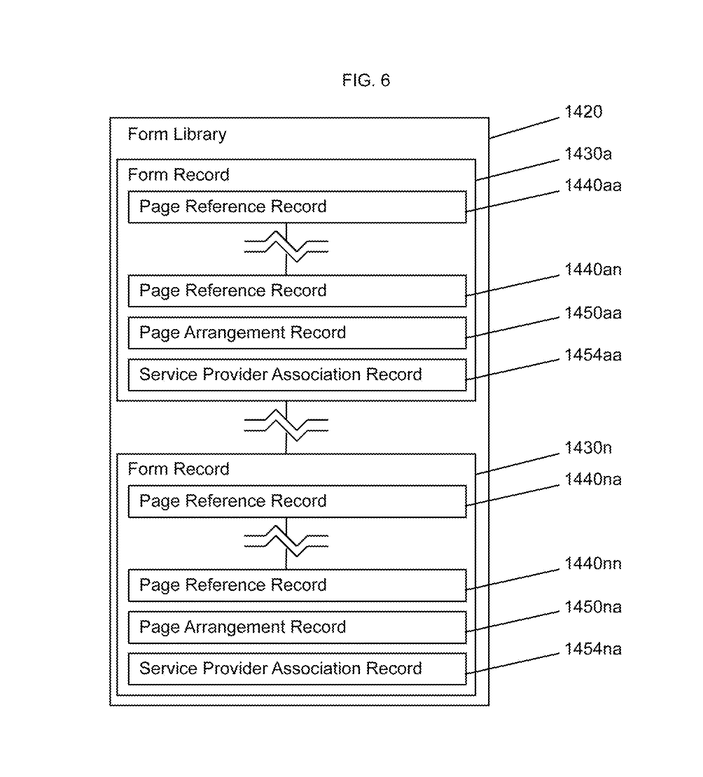

Accordingly, and referring now to FIGS. 2-6, the storage unit 1103 preferably includes an authoring software program 3100 that preferably can be executed by the processor unit 1101 and preferably can access the memory unit 1102 and the storage unit 1103.

The customized authoring functionality of the present invention preferably can be integrated with other (for example, third party) data management systems, data processing systems, and the like. Examples of such other systems include, but are not limited to, EMR, EHR, and PMS systems. Accordingly, in some embodiments, the customized authoring functionality and other features of the present invention preferably are provided through an Application Programming Interface (API), or other device(s) for integration between and among systems.

Further with regard to the customized authoring feature of the present invention, the present invention preferably enables the author (for example, a service provider) to create customized data collection points (for example, fields) and to configure all of the qualities of the data that is to be contained within those fields, including but not limited to qualities regarding display and functionality.

Qualities established by the author in these fields can include, but are not limited to, at least one of: label, font face, font size, color, mask, language, field count, text description, numerical value, coded value, logic formula, and type. These are described more specifically below.

Qualities established substantially automatically, and/or in a predefined manner, by the engine itself include, but are not limited to, at least one of: (1) standardized numerical codes with nomenclature values (for example, direct clinical nomenclature values) that can be decoded and processed by any client data storage and/or management system utilizing appropriate coding databases for the purpose of coding or interpreting coded data, and (2) interoperability instructions, for example, interoperability instructions set forth by the American Recovery and Reinvestment Act of 2009 (ARRA), which allow for integration of the data collected into any primary and/or secondary client data storage and/or management system. Preferably, designation of the foregoing qualities by manual manipulation by the author and/or by automatic (and/or predefined) assignment by the engine creates and/or assists in the creation of the data collection form.

Preferably, pre-designated numerical codes, each of which is directly related to a respective specific definition of nomenclature (for example, clinical nomenclature), are assigned to respective fields of the data collection device or form. Coding the fields preferably allows for the data to be interpreted and/or processed by another client data storage or processing system utilizing similar and/or related clinical nomenclature databases or collections of databases. Such coding functionality preferably fosters interoperability between and/or among data storage and processing systems.

Accordingly, the storage unit 1103 further preferably includes a host server database 1118. The database 1118 preferably includes a field library 1120. The field library 1120 preferably includes at least one field record 1130. Each field record 1130 preferably includes at least one field configuration parameter record 1140. Each field configuration parameter record preferably includes a field configuration parameter value 1150.

Preferably, each field record 1130 includes a respective field configuration parameter record 1140 for one or more of the following field configuration parameters: label (for example, the name of the field), font face (for example, the font type), font size (for example, the size of the font), color (for example, the color of the font), mask (for example, the forced and/or defined formatting of the field data), language (for example, the language accepted by the field as input), field count (for example, the permitted number of characters in the field), text description (for example, explanatory text for the field label), numerical value (for example, for fields permitting only data selected from a known set of possible data; this parameter holds the known set of possible data from which the selector chooses (for example, items in a drop down menu)), coded value (for example, a nomenclature code), logic formula (for example, this parameter can be used to cause the entry in the field to dictate the presence of other field(s), that is, whether or not other fields are presented or not presented; for example, a logic formula may dictate, for example, that if a field requesting data concerning a person's gender is provided data indicating a male gender, a field requesting data concerning a person's pregnancy status would not be presented), mapping (for example, this parameter can be used to cause the entry in the field to dictate the contents of other field(s), that is, auto-populate and/or pre-populate data for other fields; for example, when a field requesting data concerning a person's date of birth is provided with the date, a second field requesting data concerning a person's age is populated with the person's age, as a result of an appropriate calculation), and type (for example, the type of input mechanism used by the field, for example, text box, radio button, drop down menu, etc.).

Further with regard to the coded value parameter, an example of a preferred coded value is an industry code that is used to standardize data interpretation and/or language translation in an industry. Examples include, but are not limited to, nomenclature codes. Examples of nomenclature codes in the medical industry include one or more of the following: MEDCIN, SNOMED, RxNorm, ICD-9, ICD-10, CPT-4, LOINC, HCPCS, DSM-IV, and UNII codes. In the medical industry, these codes, which are required for various purposes by certain federal and state guidelines and laws, are designed to allow standardized patient data interpretation and to enable patient data to be translated into various languages.

In certain embodiments of the present invention, as and/or once the author selects and/or creates fields that the author desires to associate together (for example, fields that are semantically related), the fields preferably can be designated by the author as belonging to a block, or collection of fields. Preferably, blocks are stored in a database library for later use in authoring a complete data collection form or device, and preferably can be further grouped into categories. For example, preferably in some embodiments, all blocks pertaining to data collection fields that would be used to create a data collection form or device for a chiropractor could be grouped separately from blocks pertaining to data collection fields that would be used to create a data collection form or device for a cardiologist.

Accordingly, the database 1118 preferably includes a block library 1220. The block library 1220 preferably includes at least one block record 1230. Each block record 1230 preferably includes at least one field reference record 1240 and a field arrangement record 1250. Each field reference record 1240 preferably identifies a respective field record 1130. The field arrangement record 1250 preferably indicates an ordering (or other arrangement) of the respective field records 1130 (for example, the order in which the fields are to be presented in the block or, for example, the spatial arrangement of the fields within the block when presented).

Preferably, once the block library has been populated with blocks, the author can create customized arrangements of the blocks. Arranging blocks together preferably designates them as belonging to a page, or collection of blocks. Preferably, pages are stored in a database library for later use in authoring a complete data collection form or device, and preferably can be further grouped into categories. For example, preferably in some embodiments, all pages pertaining to data collection blocks that would be used to create a data collection form or device for a chiropractor could be grouped separately from pages pertaining to data collection blocks that would be used to create a data collection form or device for a cardiologist.

Accordingly, the database 1118 further preferably includes a page library 1320. The page library 1320 preferably includes at least one page record 1330. Each page record 1330 preferably includes at least one block reference record 1340 and a block arrangement record 1350. Each block reference record 1340 preferably identifies a respective block record 1230. The block arrangement record 1350 preferably indicates an ordering (or other arrangement) of the respective block records 1230 (for example, the order in which the blocks are to be presented in the page, or, for example, the spatial arrangement of the blocks within the page when presented).

Once a desired number and composition of pages has been established by the author, the author is preferably able to combine the pages to create a form, or data collection device. Forms preferably can be saved in a digital library and can be assigned to a service provider as the service provider's client data collection form or device.

Accordingly, the database 1118 further preferably includes a form library 1420. The form library 1420 preferably includes at least one form record 1430. Each form record 1430 preferably includes at least one page reference record 1440, a page arrangement record 1450, and at least one service provider association record 1454. Each page reference record 1440 preferably identifies a respective page record 1330. The page arrangement record 1450 preferably indicates an ordering (or other arrangement) of the respective page records 1330 (for example, the order in which the pages are to be presented in the form, or, for example, the spatial arrangement of the pages within the form when presented). Each service provider association record 1454 preferably identifies a respective service provider. In some embodiments, the service provider association record 1454 preferably identifies one or more service providers.

Preferably, the author is able to combine fields to establish blocks, combine blocks to establish pages, and combine pages to establish forms, using a graphical interface. Preferably, the author is able to create customized arrangements of fields within blocks, blocks within pages, and pages within forms, in one or more graphically depicted authoring areas, preferably by means of a drag-and-drop system. (For example, in a preferable drag-and-drop operation, a user (for example, the author) highlights and then selects (for example, by clicking a button on an input device such as, for example, a mouse, touch sensitive screen, or trackpad) an object (for example, a graphical user interface element representing a field, block, or page, as applicable), dragging the object to a desired position, and then releasing the selection.) For example, arranging fields within a block authoring area preferably designates the fields as belonging to a block, arranging blocks within a page authoring area preferably designates the blocks as belonging to a page, and arranging pages within a form authoring area preferably designates the pages as belonging to a form. Or, for example, the arranging preferably can occur in a single authoring area that depicts the fields, blocks, pages, and forms simultaneously.

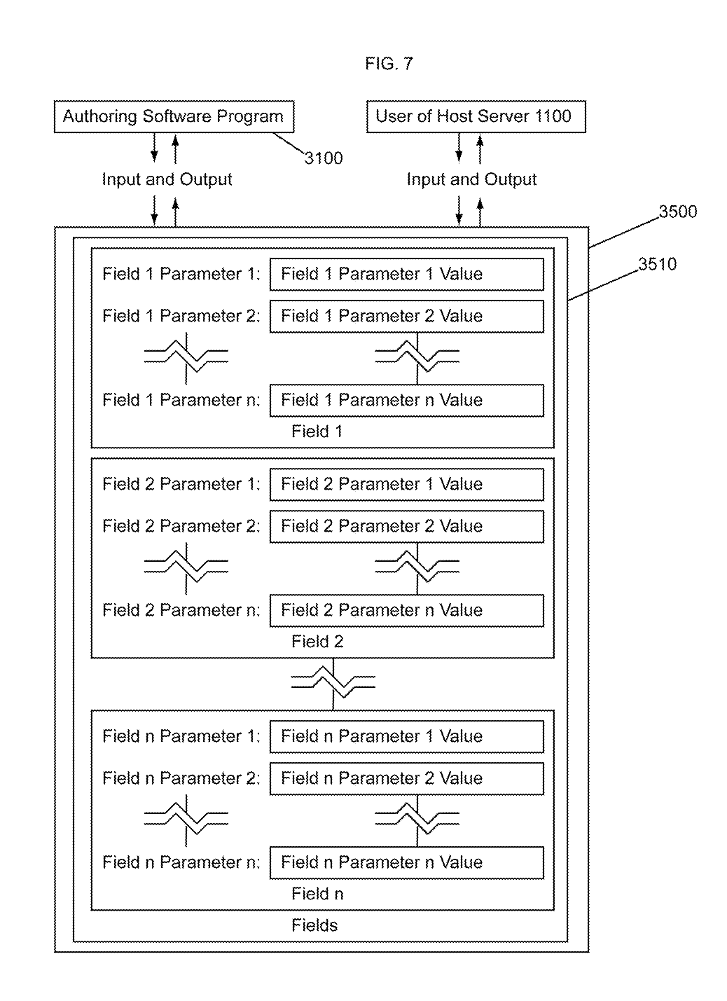

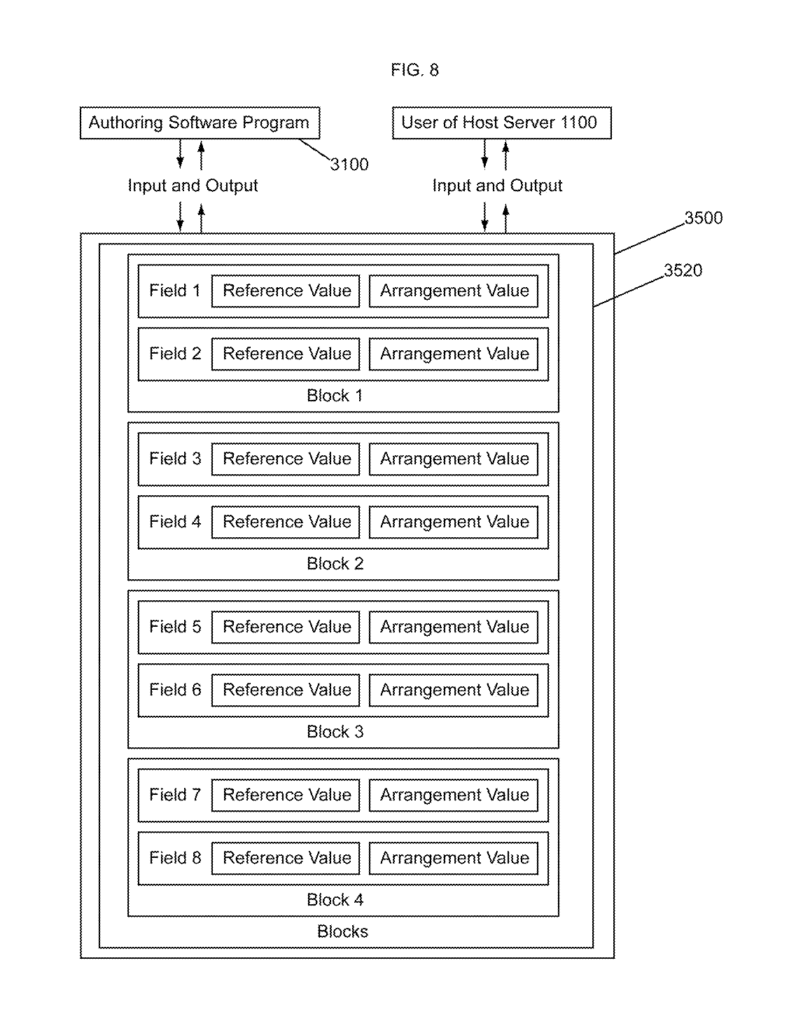

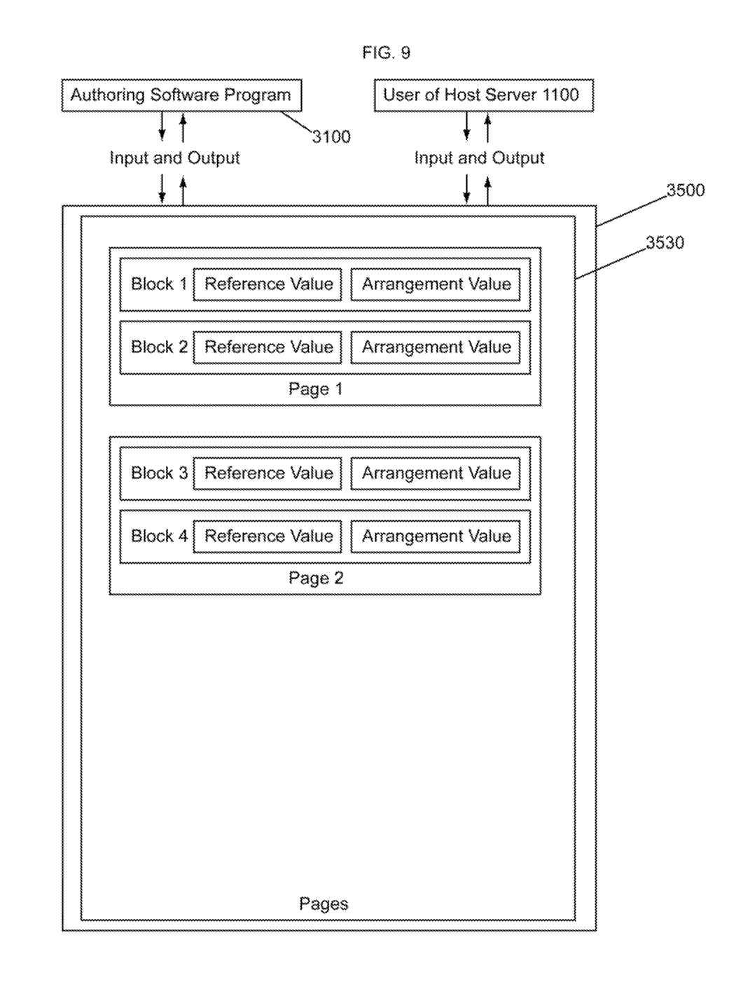

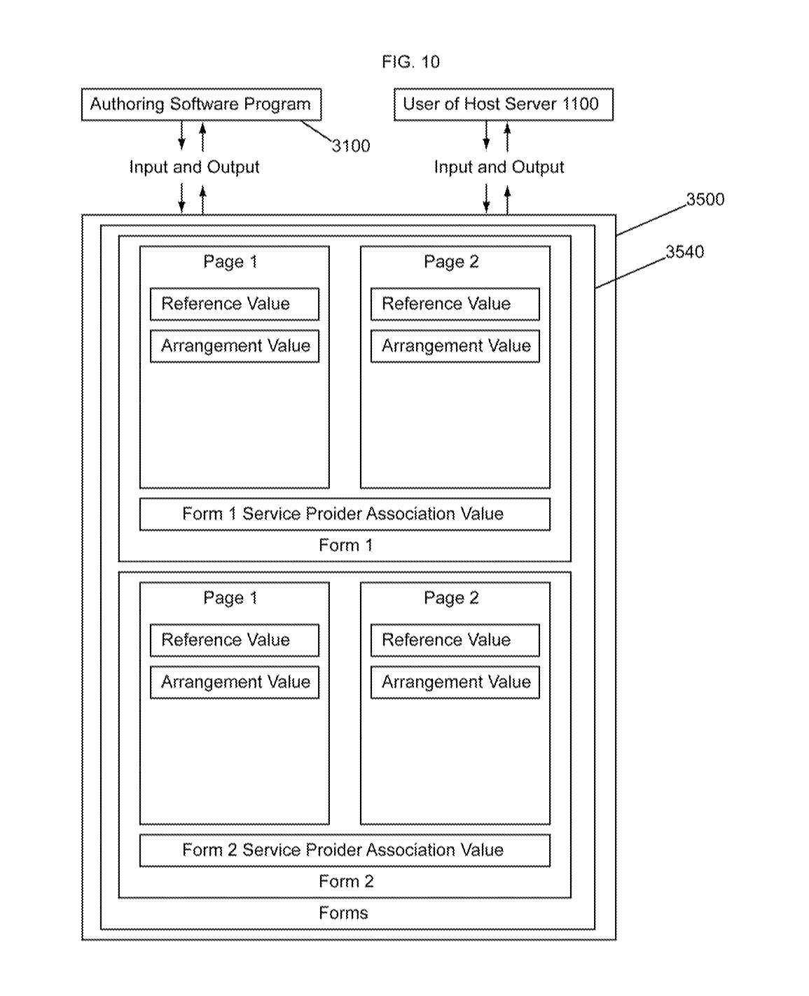

Accordingly, and referring now to FIGS. 7-11, during execution, the authoring software program 3100 preferably presents an authoring software program user interface 3500. By way of the user interface 3500, the authoring software program 3100 preferably receives input from, and sends output to, a user of the host server 1100.

The user interface 3500 preferably includes a field configuration interface 3510. By way of the field configuration interface 3510, the authoring software program 3100 preferably receives, for association with each of one or more field records 1130, at least one field configuration parameter value 1150. The authoring software program 3100 preferably stores each field configuration parameter value 1150 in an associated field configuration parameter record 1140 of the associated field record 1130 in the field library 1120 of the database 1118.

The user interface 3500 preferably includes a block configuration interface 3520. By way of the block configuration interface 3520, the authoring software program 3100 preferably receives, for association with each of one or more block records 1230, at least one field reference value 1260, and at least one field arrangement value 1270. The authoring software program 3100 preferably stores each field reference value 1260 in an associated field reference record 1240 in the associated block record 1230 in the block library 1220 of the database 1118. The authoring software program 3100 preferably stores the at least one field arrangement value 1270 in an associated field arrangement record 1250 in the associated block record 1230 in the block library 1220 of the database 1118.

The user interface 3500 preferably includes a page configuration interface 3530. By way of the page configuration interface 3530, the authoring software program 3100 preferably receives, for association with each of one or more page records 1330, at least one block reference value 1360, and at least one block arrangement value 1370. The authoring software program 3100 preferably stores each block reference value 1360 in an associated block reference record 1340 in the associated page record 1330 in the page library 1320 of the database 1118. The authoring software program 3100 preferably stores the at least one block arrangement value 1370 in an associated block arrangement record 1350 in the associated page record 1330 in the page library 1320 of the database 1118.

The user interface 3500 preferably includes a form configuration interface 3540. By way of the form configuration interface 3540, the authoring software program 3100 preferably receives, for association with each of one or more form records 1430, at least one page reference value 1460, at least one page arrangement value 1470, and at least one service provider association value 1474. The authoring software program 3100 preferably stores each page reference value 1460 in an associated page reference record 1440 in the associated form record 1430 in the form library 1420 of the database 1118. The authoring software program 3100 preferably stores each page arrangement value 1470 in an associated page arrangement record 1450 in the associated form record 1430 in the form library 1420 of the database 1118. The authoring software program 3100 preferably stores each service provider association value 1474 in an associated service provider association record 1454 in the associated form record 1430 in the form library 1420 of the database 1118.

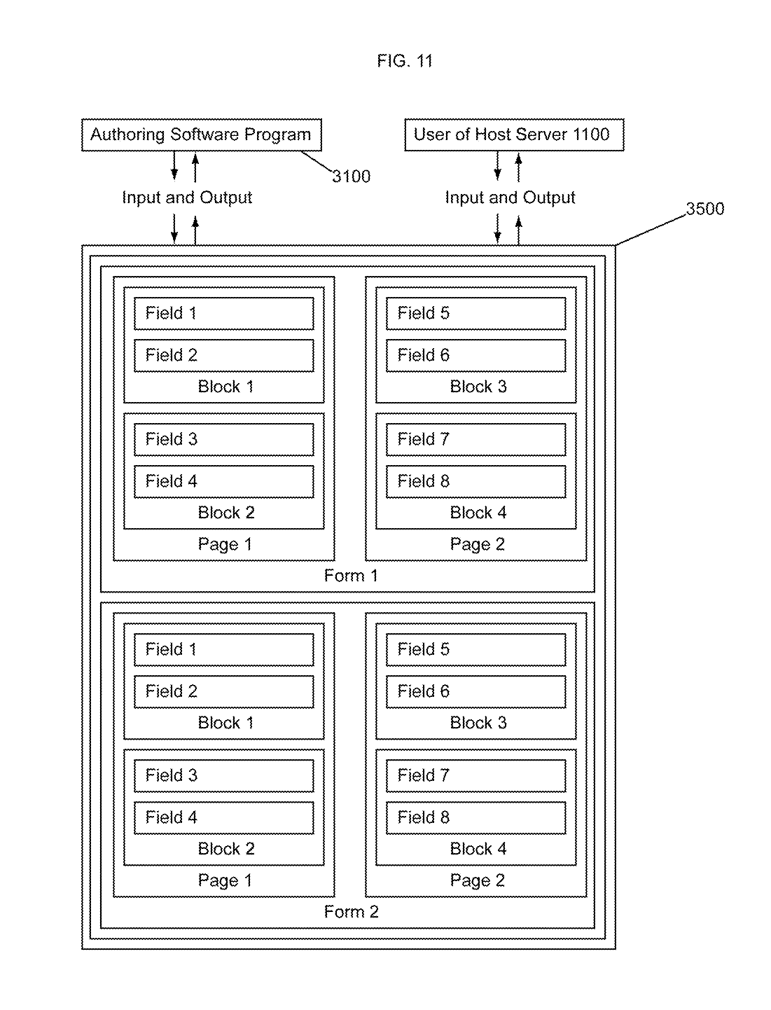

In some embodiments, as shown in FIGS. 7-10, the reference values and arrangement values preferably can be provided through text entry boxes of the user interface. In other embodiments, as shown in FIG. 11, the reference values and arrangement values preferably can be provided by way of a drag-and-drop interface or similar interface of the user interface.

Also preferably, in some embodiments, the reference values and/or arrangement values can be provided by configuring one or more graphical, diagrammatic, animated, and/or interactive renderings of various anatomical representations. Preferably, such representations can include an entire subject's anatomy (for example, an entire body of a person, preferably sub-divided) and/or selected portions of a subject's anatomy (for example, a portion of a body of a person, such as, for example, a face). Preferably, during data collection, a client can provide data by assigning physical conditions to individual sections of the represented anatomy by clicking on the sections and then either manually typing in a description of the conditions and/or selecting variants of a condition or various aspects of a condition from a series of menus that serve to describe the condition in detail (for example, this preferably can be tailored to the type of clinical data that is to be obtained, such as, for example, for a pain assessment, various aspects of a pain condition could include, for example, level, quality, onset, and/or timing, and each of such aspects could have variants including, for example, for level (for example, low, medium, or high), for quality (for example, poor, normal, or good), for onset (for example, sudden or gradual), and/or for timing (for example, a date and/or time), from which to select to provide additional detail). Preferably, all of the information is then automatically, and/or in a predefined manner, coded using an appropriate nomenclature database.

Preferably, using such features of the present invention, accordingly, at least one, and preferably a plurality, of field records 1130 are created and stored in the database 1118. Preferably, further accordingly, at least one, and preferably a plurality of block records 1230 are created, by adding field reference values 1260 and specifying field arrangement values 1270, and stored in the database 1118. Preferably, further accordingly, at least one, and preferably a plurality of page records 1330 are created, by adding block reference values 1360 and specifying block arrangement values 1370, and stored in the database 1118. Preferably, further accordingly, at least one, and preferably a plurality of form records 1430 are created, by adding page reference values 1460 and specifying page arrangement values 1470 and service provider association values 1474, and stored in the database 1118.

Preferably, further accordingly, by operation of the authoring software program 3100, the database 1118 is populated with at least one and preferably a plurality of form records 1430, each being associated with at least one service provider, as established by the service provider association values 1474 in the service provider association records 1454 in the form records 1430.

Preferably during form authoring, in an exemplary embodiment the present invention automatically and/or simultaneously and/or using pre-defined data sets creates one or more of the following: (1) the client-facing HTML version of the data collection form that will serve as the client interface for data collection from the client; (2) the database in which the collected data will be stored; (3) the instructions for auto-population and/or pre-population of data (for example, mapping) from one relative field to another within the form and/or from one relative field to another in any separate and/or subsequent form the client may use to submit data; (4) the assignment of appropriate universal nomenclature codes to be applied to the data entered into the data collection fields; (5) the interoperability instructions outlining how the data is to be passed between any applicable data collection, storage, or processing systems; (6) instructions for formatting the fields and/or data in a PDF framework rendered in accordance with the author's needs (for example, in the medical industry, service providers (for example, physicians) need to show proof that clients (for example, patients) have been appropriately given an opportunity to see required data that has been and/or is to be gathered, and/or see that required data has not been gathered and/or is indicated as such; and, for example, in the medical industry, clients (for example, patients) and/or service providers (for example, physicians) must retain signed (for example, electronically or otherwise) copies for historical records, to show that the act of registration (that is, registration being, for example, the entry of data and acknowledgement of its truthfulness and accuracy by the patient, as opposed to an entry of data without such registration, which does not provide an indication of ownership of entry by the patient) has taken place; for example, having documented evidence signed by the patient of the completed and not-completed fields reduces physician liability and places responsibility with the patient).

For example with regard to the automatic and/or simultaneous creation of the client-facing HTML version of the data collection form that will serve as the client interface for data collection from the client, each field record 1130 preferably contains HTML formatting instructions related to the field. Preferably, as fields are organized (for example, dragged and dropped) to establish blocks during form authoring, block records 1230 are created and caused to include HTML formatting instructions related to the respective blocks. Further preferably, as blocks are organized (for example, dragged and dropped) to establish pages during form authoring, page records 1330 are created and caused to include HTML formatting instructions related to the respective pages. Further preferably, as pages are organized (for example, dragged and dropped) to establish forms during form authoring, form records 1430 are created and caused to include HTML formatting instructions related to the respective forms.

For example with regard to the automatic and/or simultaneous creation of the instructions for formatting the fields and/or data in a PDF framework rendered in accordance with the author's needs, each field record 1130 preferably contains PDF formatting instructions related to the field. Preferably, as fields are organized (for example, dragged and dropped) to establish blocks during form authoring, block records 1230 are created and caused to include PDF formatting instructions related to the respective blocks. Further preferably, as blocks are organized (for example, dragged and dropped) to establish pages during form authoring, page records 1330 are created and caused to include PDF formatting instructions related to the respective pages. Further preferably, as pages are organized (for example, dragged and dropped) to establish forms during form authoring, form records 1430 are created and caused to include PDF formatting instructions related to the respective forms. It should be understood that the storing of PDF formatting instructions in the database records preferably results in less storage space being required for the data (preferably, PDF images, which take up greater storage capacity than the PDF formatting instructions, are not stored; however, the present invention contemplates the additional or alternative storage of PDF images, if desired) and easier portability of the data (preferably, no PDF image needs to be sent when transferring data, preferably because preferably, the instructions can be accessed at any time during operation of the system to generate a PDF formatted copy of the data in one or more records).

The customization feature of the present invention preferably is automatic and/or simultaneous and/or uses pre-defined and/or pre-configured data sets and/or requirements and preferably includes customization of/for, for example, layout, spacing, numbering, font, data placement, interoperability instructions (for example, as described above), mapping instructions (for example, as described above), HTML formatting instructions (for example, as described above), PDF formatting instructions (for example, as described above), and/or embedding of codes (for example, clinical nomenclature codes as described above) when applicable. For example, preferably, in some embodiments, codes and/or instructions and/or other data are embedded in field records and/or other records (for example, pre-defined for such field records and/or such other records), so that as the form is being authored, the necessary codes and/or instructions and/or other data for the form are established without additional input being required (for example, the placement of fields, blocks, and pages (for example, to create forms) automatically carries with each component (for example, fields, blocks, and pages) the component's instructions and does not require new instructions when assembling the components together into a form).

Although a PDF file and/or PDF document is preferably generated automatically in real-time during a client's entering of data into the client-facing HTML (for example, such automatic generation preferably using the aforementioned PDF formatting instructions), the appearance of the client-facing HTML versus the PDF file and/or PDF document are preferably distinguishable by virtue of (1) the distinct needs of the client at the point of data entry (for example, website data entry) for ease of use and data entry (for example, the client-facing HTML format is preferably used for client data entry via a website interface, to ease such data entry and integrate with other HTML (and other) functionality of the present invention; for example, use of the HTML form provides for the use of advanced form completion logic (for example, displaying (or not displaying) or asking for (or not asking for) information based on a previous form inquiry, such as, for example, not asking a male respondent to complete a gynecological history, or, for example, not requesting a detailed pain evaluation from a patient not experiencing pain)), and (2) the distinct needs of the service provider with respect to lawfully reading, using, and/or storing hard copy printed documentation (for example, the PDF format is preferably used when clients and/or service providers require hard copies of client data, for legal, ethical, or other reasons, such as, for example, in the medical industry, physicians may be required by law to maintain paper copies of patient registration data; or, for example, when the data is stored in an encrypted database as field data and not as a PDF image, the data can be more securely stored and/or more easily manipulated, and using the functionality of the present invention, the generation of the PDF formatted file or document is preferably created in real-time on demand, to provide such a format when required).

It should be understood that the authoring functionality of the present invention preferably is additionally used to enable service providers to edit and/or otherwise modify data collections forms that have been authored.

It should further be understood that assignments of data collection forms using the present invention preferably can be edited and/or otherwise modified to assign existing forms to fewer, more, and/or different service providers than the service provider(s) to whom they were previously assigned.

It should further be understood that data collection forms preferably can be assigned to entire service provider groups, and/or to one or more service providers within a service provider group, and further preferably that one or more service providers within a service provider group can be assigned different forms than one or more other services providers within the service provider group.

Once data collection forms have been authored and assigned to appropriate service providers, the service providers preferably can use a client data management system of the present invention (which is secure and Internet-based in preferred embodiments) to deploy the data collection forms and manage the collected data and/or results.

More specifically in certain embodiments, the client data management system of the present invention preferably includes at least one or more of the following features: (1) client registration; (2) client authorization; (3) insurance verification; (4) appointment reminders; (5) appointment scheduling; (6) PDF generation; (7) specialized format generation; (8) client referral; (9) service provider subscription; and (10) secure messaging and data storage and transmission. Additional descriptions of these features are provided herein.

In preferred embodiments of the present invention, a client registration system of the present invention preferably includes communication between a service provider and a client, preferably using network enabled devices (for example, computers, tablets, smartphones, appliances, and the like) and communication tools (for example, in-person, phone, e-mail, text messaging, and/or other electronic messaging tools).

Selection devices discussed herein preferably include any hardware or software device, on any user interface or otherwise, that can be used to select a physical or software represented (for example, on a graphical user interface) object, item, choice, or other selection target. Examples include, but are not limited to, hyperlinks, addresses, names, buttons, radio buttons, drop down menus, text entry boxes, check boxes, icons, images, videos, drawings, representations, and the like.

Websites and website addresses are discussed herein merely as examples of network locations and network location addresses, respectively. Accordingly, the present invention encompasses the use of network locations other than websites and network location addresses other than website addresses, and the discussions herein should be construed broadly to encompass any type of network locations and any type of network location addresses.

Encounters (for example, the subject of registration, scheduling, reminders, etc.) between clients and service providers are discussed herein, and should be construed broadly to mean any type of encounter and/or other interaction between a client and a service provider. Examples include, but are not limited to, appointments, reservations, transactions, dealings, conversations, meetings, and the like).

Purposes of data collection are discussed herein as registration, but it should be understood that the present invention encompasses any purpose for data collection, and that registration is one example only. Examples include, but are not limited to, registration, demographic analysis, research, education, marketing, commercial purposes, and the like.

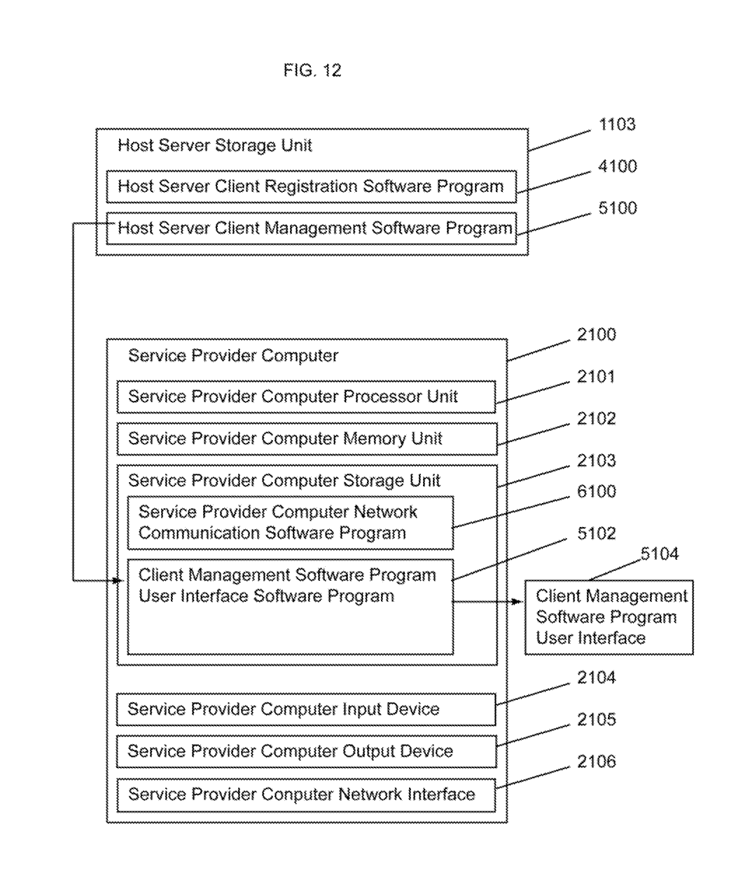

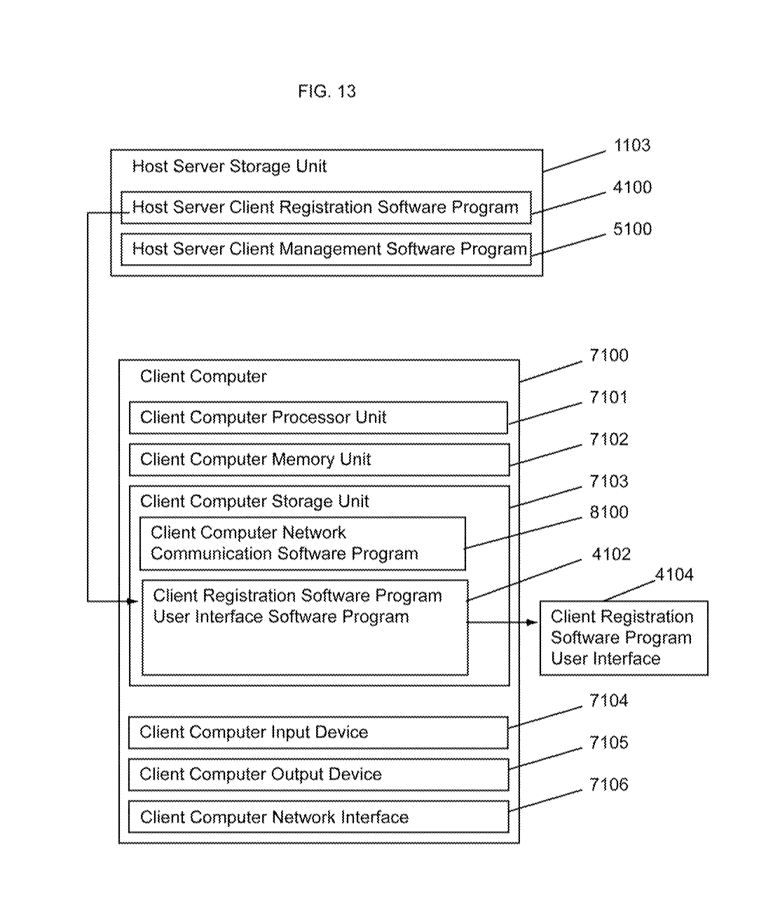

Accordingly, more specifically with regard to the client registration functionality of the present invention, and referring now to FIGS. 12 and 13, the storage unit 1103 further preferably includes a host server client registration software program 4100 that preferably can be executed by the processor unit 1101 and access the memory unit 1102 and the storage unit 1103.

The storage unit 1103 further preferably includes a host server client management software program 5100 that preferably can be executed by the processor unit 1101 and access the memory unit 1102 and the storage unit 1103.

The system further preferably includes a service provider computer 2100. The service provider computer 2100 preferably includes a service provider computer processor unit 2101, a service provider computer memory unit 2102, a service provider computer storage unit 2103, a service provider computer input device 2104, a service provider computer output device 2105, and a service provider computer network interface 2106.

The storage unit 2103 preferably includes a service provider computer network communication software program 6100 (for example, an Internet browser, and/or another network enabled server program that communicates with a corresponding network enabled client program running on a client machine) that preferably can be executed by the processor unit 2101 and access the memory unit 2102 and the storage unit 2103.

The system further preferably includes a client computer 7100. The client computer 7100 preferably includes a client computer processor unit 7101, a client computer memory unit 7102, a client computer storage unit 7103, a client computer input device 7104, a client computer output device 7105, and a client computer network interface 7106.

The storage unit 7103 of the client computer 7100 preferably includes a client computer network communication software program 8100 (for example, an Internet browser, and/or another network enabled client program that communicates with a corresponding network enabled server program running on a client machine) that preferably can be executed by the processor unit 7101 and access the memory unit 7102 and the storage unit 7103.

During execution, the client management software program 5100 preferably sends to the service provider computer 2100 a client management software program user interface software program 5102 that preferably can be executed by the network communication software program 6100. During execution, the user interface software program 5102 preferably presents a client management software program user interface 5104. By way of the user interface 5104, the client management software program 5100 preferably receives input from a user of the service provider computer 2100, and sends output to the user of the service provider computer 2100.

During operation of the client registration system of the present invention, a service provider preferably receives from a client a request for an encounter with the service provider.

In some embodiments, the service provider preferably can direct the client to a system component that the client preferably can use to initiate registration for an encounter with the service provider.

Further in these and/or other embodiments, the service provider preferably can send to the client tools the client preferably can use to initiate registration for an encounter with the service provider.

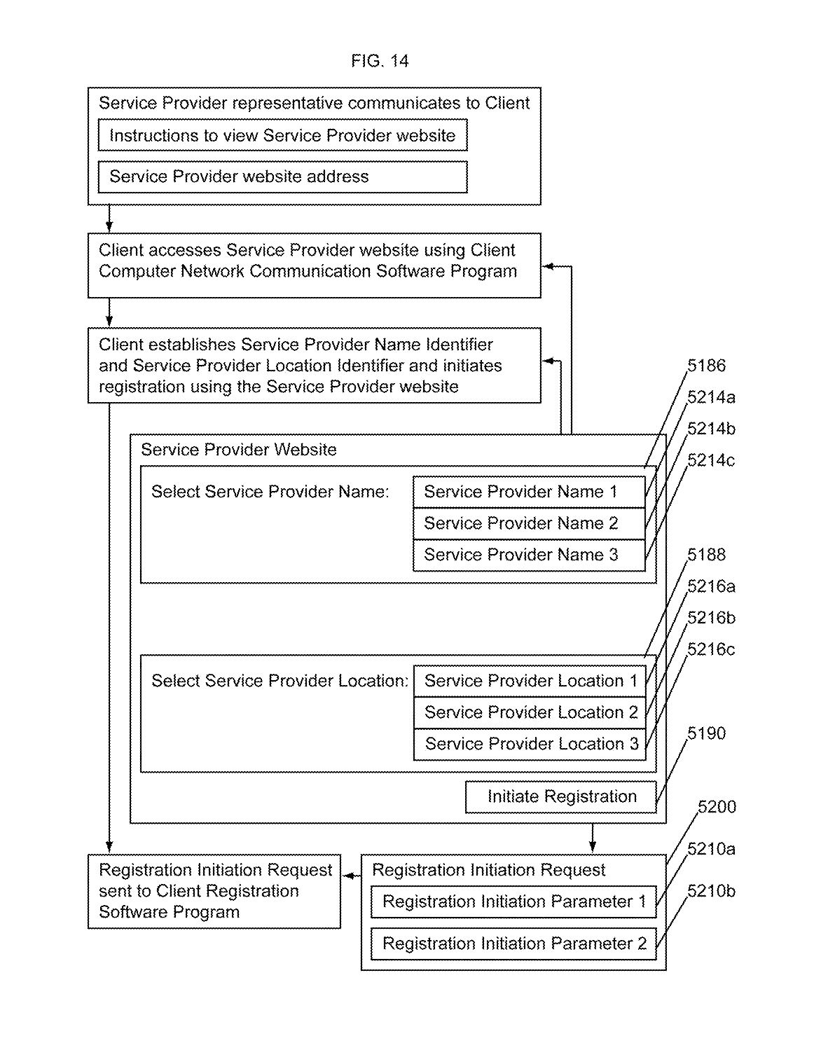

Accordingly, more specifically with regard to embodiments in which a service provider preferably can direct the client to a system component that the client preferably can use to initiate registration for an encounter with the service provider, for example, and referring now to FIG. 14, a service provider representative preferably instructs a client to view a website of the service provider, and preferably provides to the client a website address of the website. The client preferably uses the client computer network communication software program 8100 to view the website.

The website preferably presents a service provider name selection device 5186, by which the user of the client computer 7100 preferably establishes a service provider name identifier 5214, which preferably identifies the name of the service provider with which the user of the client computer desires to schedule the encounter.

The website further preferably presents a service provider location selection device 5188, by which the user of the client computer 7100 preferably is able to establish a service provider location identifier 5216, which preferably identifies the service provider's office location at which the user of the client computer desires to schedule the encounter.

The website further preferably presents a registration initiation device 5190. When activated, the registration initiation device 5190 preferably sends to the client registration software program 4100 a registration initiation request 5200. The registration initiation request 5200 preferably includes at least one registration initiation parameter 5210.

Preferably, the at least one registration initiation parameter 5210 preferably includes one or more of the following: (1) the service provider name identifier 5214, and (2) the service provider location identifier 5216.

Additionally or alternatively, and more specifically with regard to embodiments in which a service provider preferably can send to the client tools the client preferably can use to initiate registration for an encounter with the service provider, for example, once a service provider is made aware (for example, through in-person, telephone, electronic mail communication, texting, a client management system of the present invention, or other means of communication) that the client desires to seek the services of the service provider, the service provider preferably can send to the client the registration initiation tools.

More specifically with regard to a client management system of the present invention, for example, in some embodiments, a service provider preferably can log into a client management system administration area and can be made aware that a client has requested an encounter. The service provider preferably can select a registration initiation request device (for example, a “Send Registration Request” link), and indicate (1) the specific provider, of the service provider's service provider group, that the client will be assigned to see (for example, the specific physician the patient will be assigned to see), (2) the registration form assigned to that specific service provider, and/or (3) the location at which the encounter will take place. The service provider preferably then inputs the client's electronic mail address, appointment date and/or time, and/or an indication whether (or not) to (1) remind the client of the appointment 24 hours (for example, and/or another time interval) beforehand, preferably using an electronic mail message and/or an SMS text message, and/or (2) send directions (with or without a map) to the client.

Preferably, an appointment reminder functionality of the present invention includes clients and service providers being able to set reminder preferences, such as, for example, communication method (for example, text message, electronic mail, voicemail, social messaging, and the like), communication timeframes (for example, the amount of time before the encounter that the reminder should be sent), and/or communication frequencies (for example, how many reminders should be sent before the encounter and at what frequency).

Preferably, and more specifically with regard to an appointment reminder functionality of the present invention, for example, when a client (for example, patient) is scheduling an encounter (for example, appointment) and/or the service provider's office staff is collecting information from the client that can be used to send a registration link to the client (preferably via electronic mail and/or text message), the client preferably can opt to (1) have uni-directional and/or bi-directional appointment reminders sent to the client 24 hours (and/or another time interval) in advance of the appointment (preferably via electronic mail and/or SMS text message) and/or establish a frequency of such reminders (for example, multiple reminders at specified intervals), and/or (2) have directions and/or a map sent to the client. Preferably, these reminders are sent out in a batch at a pre-determined time (for example, the morning before the day of the applicable appointments and/or another time point before the applicable appointments). This feature preferably allows the service provider's office staff to reschedule clients if necessary and/or fill appointments that were canceled. Preferably, when a client receives an appointment reminder (for example, via electronic mail), the client can respond to the reminder message, preferably by, for example, clicking one or more (preferably at least three) buttons (or other selection devices) contained within the message. These responses preferably include, but are not limited to, at least one of: “Confirm”, “Cancel”, and “Reschedule”. Additionally or alternatively, preferably, when a client receives an appointment reminder (for example, via SMS text message), the client can respond to the reminder message, preferably by sending back a response (for example, texting back a response). These responses preferably include, but are not limited to, at least one of: “1” to confirm, “2” to cancel, and “3” to reschedule. Further preferably, when a client receives an appointment reminder, the client also receives a link to a map preferably providing directions to the upcoming appointment. Preferably, all responses to appointment reminders can be viewed (preferably in table form) by the service provider's office staff, preferably under a “Reminders” tab in an administration dashboard of the data management system.

Preferably, an appointment scheduling functionality of the present invention includes service providers being able to establish an inventory of available times, and, preferably, such available times are known to the system and accordingly become available in real-time, and further accordingly as the available times are taken, they are removed from the inventory and accordingly can no longer be chosen by clients.

Preferably, and more specifically with regard to an appointment scheduling functionality of the present invention, for example, when a client (for example, patient) calls to schedule an encounter (for example, appointment), the service provider can set the encounter in a “Send Registration Request” (for example) (or “Send Client Request”, for example) box. Once set, the encounter will preferably appear in a scheduler (for example, a calendar format scheduler) that preferably can be accessed by the service provider via a “Scheduler” tab (for example) in an administration dashboard and/or panel of the data management system. Should the service provider choose to schedule the client's encounter in the aforementioned scheduler rather than in the aforementioned “Send Registration Request” (for example) (or “Send Client Request”, for example) box, the “Send Registration Request” (for example) (or “Send Client Request”, for example) box preferably will appear once the encounter has been set in the scheduler. This preferably will allow the service provider to complete the registration request without needing to navigate to another screen. Should a client's encounter need to be rescheduled, the service provider preferably can reschedule it preferably by dragging and dropping the appointment to another day and/or time. Client encounters preferably are also color coded to coincide with and/or identify parameters defined by the service provider (for example, green=teeth cleaning, red=root canal).

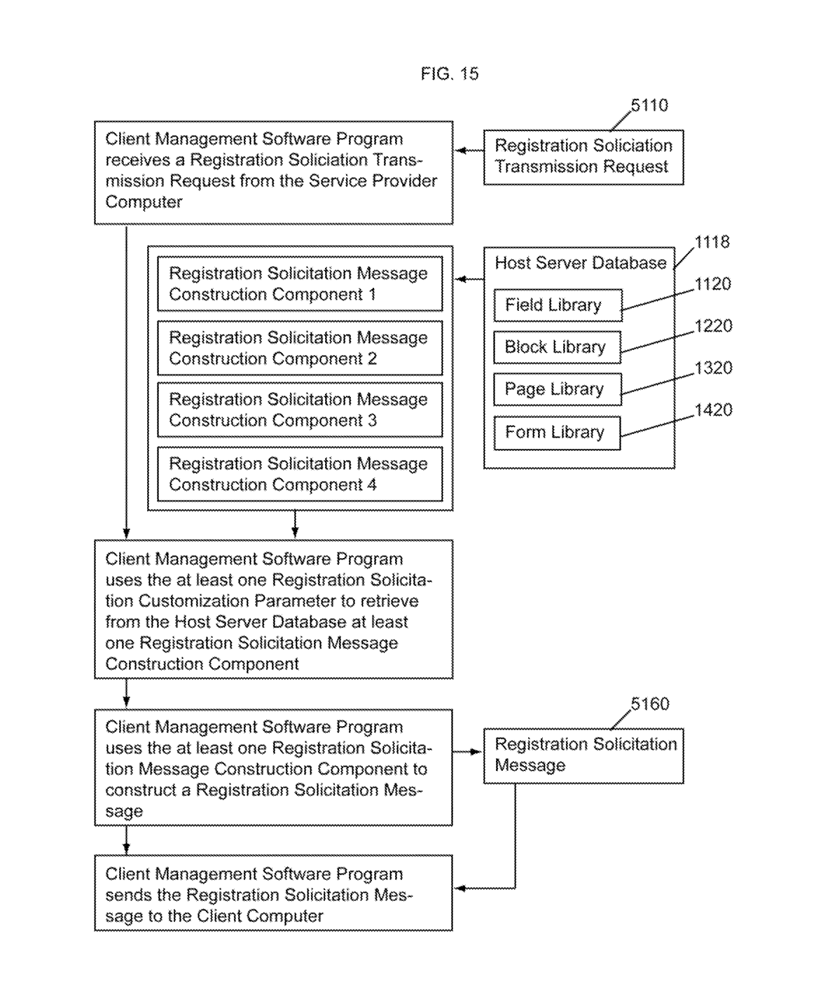

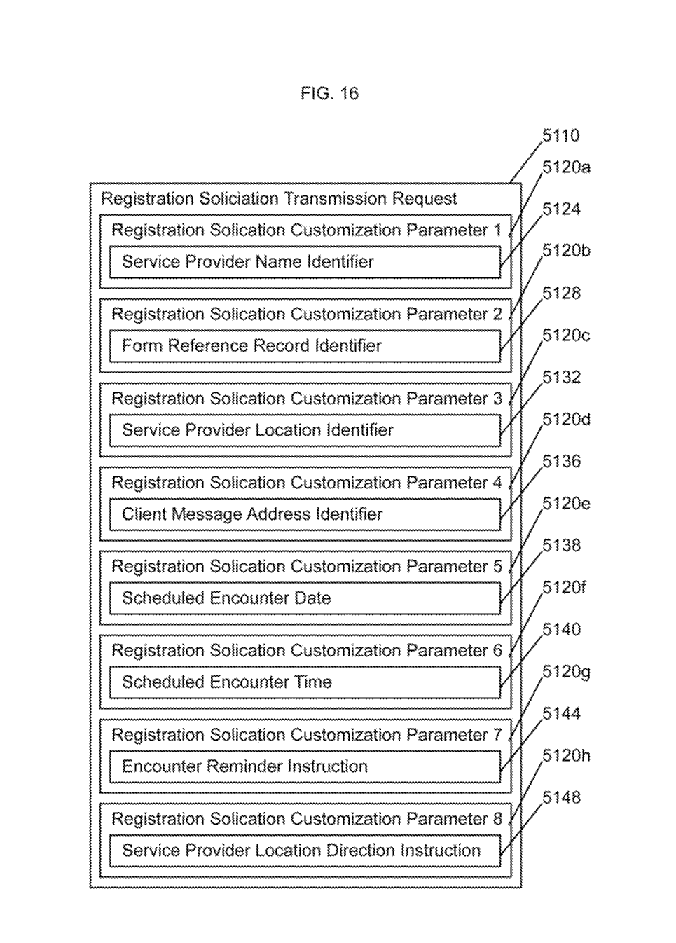

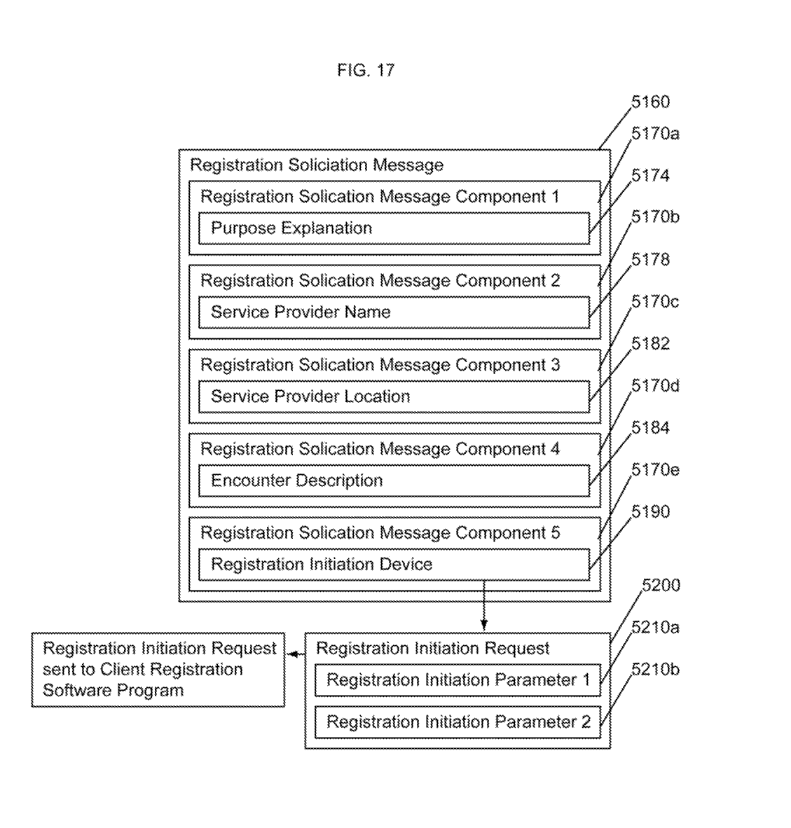

Accordingly in such embodiments, for example, and referring now to FIGS. 15, 16 and 17, additionally or alternatively, during execution, the client management software program 5100 preferably receives a registration solicitation transmission request 5110 from the service provider computer 2100. The registration solicitation transmission request 5110 preferably includes at least one registration solicitation customization parameter 5120.

Preferably, the at least one registration solicitation customization parameter 5120 preferably includes one or more of the following: (1) a service provider name identifier 5124 (for example, a service provider name), (2) a form reference record identifier 5128 (for example, a value that preferably identifies a form record), (3) a service provider location identifier 5132 (for example, a service provider location address), (4) a client message address identifier 5136 (for example, an electronic mail address, phone number, or text message number), (5) a scheduled encounter date 5138 (for example, an appointment date), (6) a scheduled encounter time 5140 (for example, an appointment time), (7) an encounter reminder instruction 5144 (for example, an instruction to send to the client message address a reminder regarding the scheduled encounter, within a specified time interval prior to the scheduled encounter), and (8) a service provider location direction instruction 5148 (for example, an instruction to send to the client message address directions to the service provider location).

After receipt of the registration solicitation transmission request 5110, the client management software program 5100 preferably accesses the database 1118, uses the at least one registration solicitation customization parameter 5120 to retrieve from the database 1118 at least one registration solicitation message construction component 5150, uses the at least one registration solicitation message construction component 5150 to construct a registration solicitation message 5160, and sends to the client computer 7100 the registration solicitation message 5160.

The registration solicitation message 5160 preferably includes at least one registration solicitation message component 5170. Preferably, the at least one registration solicitation message component 5170 includes one or more of the following: (1) a purpose explanation 5174 (for example, an explanation as to the purpose of the registration solicitation message 5160), (2) a service provider name 5178 (for example, the name of the service provider that will be conducting the scheduled encounter), (3) a service provider location 5182 (for example, the location at which the scheduled encounter is to take place), (4) an encounter description 5184 (for example, a description of the encounter agenda), and (5) a registration initiation device 5190 (for example, a hyperlink).

When activated, the registration initiation device 5190 preferably sends to the client registration software program 4100 a registration initiation request 5200. The registration initiation request 5200 preferably includes at least one registration initiation parameter 5210. Preferably, the at least one registration initiation parameter 5210 preferably includes one or more of the following: (1) the service provider name identifier 5124, and (2) the service provider location identifier 5126.

Once the client navigates to (for example, on a website) or receives (for example, in an electronic mail message) the registration initiation device, the client can preferably activate the registration initiation device and as a result is preferably delivered to a registration portal (for example, website). Preferably, the link to the portal and transmissions involving the portal are encrypted and otherwise secure. Preferably at the portal, the client is presented with the registration form, preferably in HTML format. Also preferably, the portal is branded with names, logos, slogans, trademarks, and/or trade dress items of the service provider.

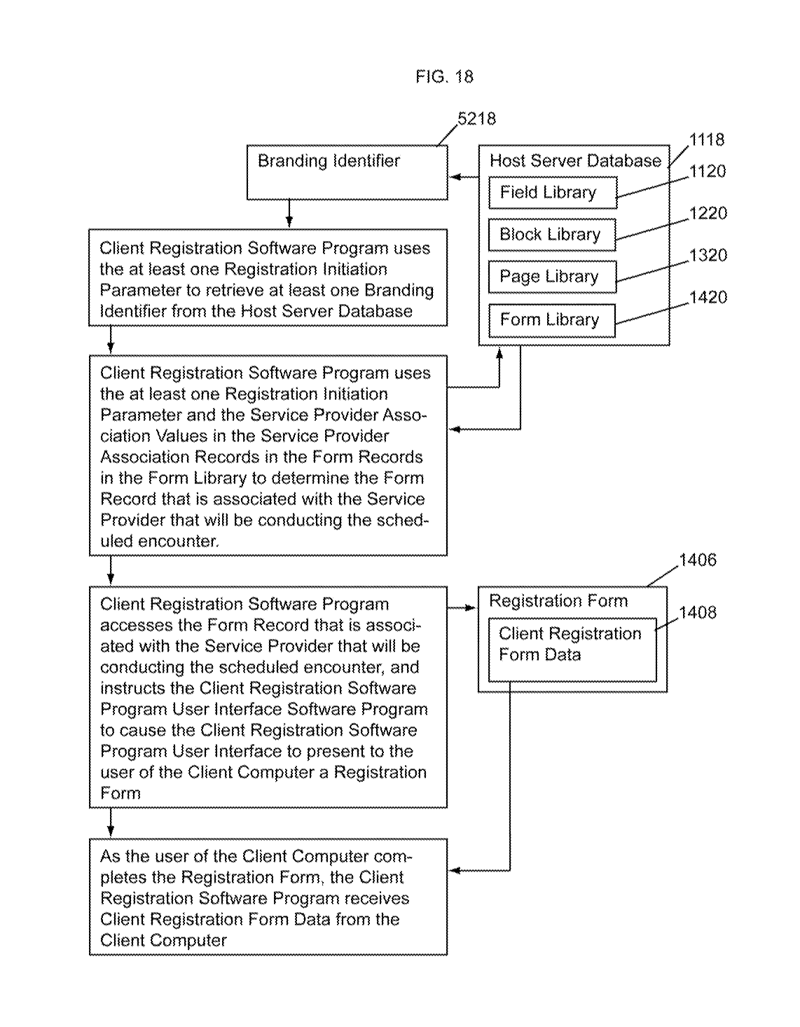

Accordingly, and referring now to FIG. 18, the client registration software program 4100 preferably uses the at least one registration initiation parameter 5210 to retrieve at least one branding identifier 5218 from the database 1118. The at least one branding identifier 5218 preferably includes at least one of the following: (1) a name of the service provider's practice, (2) at least one image associated with the service provider's practice (for example, a service provider's practice's name and/or picture), and (3) at least one image associated with the service provider (for example, a service provider's name and/or picture).

The client registration software program 4100 preferably uses the at least one registration initiation parameter 5210 and the service provider association values 1474 in the service provider association records 1454 in the form records 1430 in the form library 1420 to determine the form record 1430 that is associated with the service provider that will be conducting the scheduled encounter.

Referring now also again to FIG. 13, the client registration software program 4100 preferably sends to the client computer 7100 a client registration software program user interface software program 4102 that preferably can be executed by the network communication software program 8100. During execution, the user interface software program 4102 preferably presents a client registration software program user interface 4104. By way of the user interface 4104, the client registration software program 4100 preferably receives input from, and sends output to, a user of the client computer 7100.

The client registration software program 4100 preferably accesses the form record 1430 that is associated with the service provider that will be conducting the scheduled encounter, and instructs the user interface software program 4102 to cause the user interface 4104 to present to the user of the client computer 7100 a registration form 4106.

As the user of the client computer 7100 completes the registration form 4106 using the user interface 4104, the client registration software program 4100 preferably receives client registration form data 4108 from the client computer 7100.

Preferably, once the client has completed the registration form, the client preferably submits the form, and/or confirms that the information provided is correct, preferably by clicking a “Submit” button or the like.

Further preferably, if applicable for the given industry or purpose of the data collection, the client preferably is requested to complete and submit authorization documents by which the client grants to the service provider permission to use, or have others use, the collected data for certain purposes. For example, in the medical industry, it may be necessary for the client to grant permission for the service provider to share health information with third parties, such as, for example, insurance companies and/or physicians and/or other service providers.

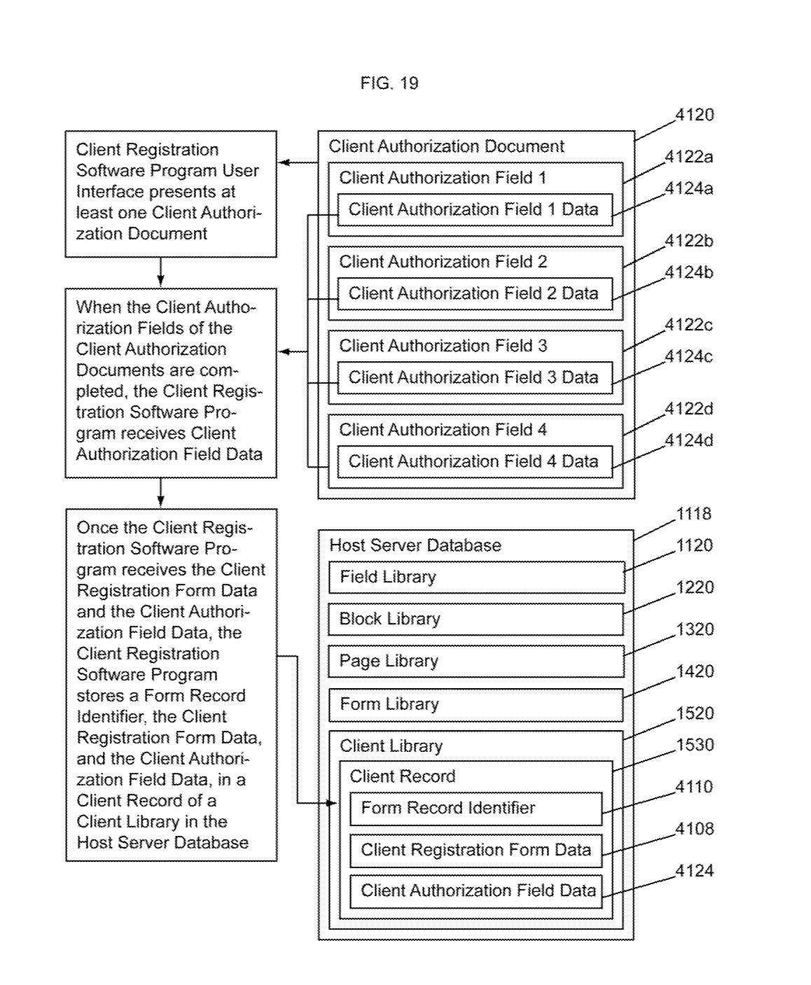

Accordingly, and referring now to FIG. 19, the user interface 4104 preferably presents to the user of the client computer 7100 at least one client authorization document 4120. The at least one client authorization document 4120 preferably includes one or more of the following: (1) an authorization for use and/or disclosure of protected health information form, (2) lifetime authorization insurance assignments and/or an authorization to release information form, and (3) a HIPAA notice of privacy practices form.

Each client authorization document 4120 preferably includes at least one respective client authorization field 4122. The at least one respective client authorization field 4122 preferably includes one of more of the following fields: (1) name of the client providing authorization, (2) Internet (or other network) protocol address of the computer used to provide authorization, (3) date the authorization was provided, and (4) time the authorization was provided.

When the user of the client computer 7100 completes the client authorization field 4122 for each of the client authorization documents 4120, the client registration software program 4100 preferably receives client authorization field data 4124 from the client computer 7100. The client authorization field data 4124 preferably includes data for each client authorization field 4122. The client authorization field data 4124 accordingly, preferably, includes at least one of the following: (1) name of the client, (2) Internet (or other network) protocol address of the client computer 7100, (3) date the client authorization field data 4124 was provided, and (4) time the client authorization field data 4124 was provided.

Preferably, once the client registration software program 4100 receives the client registration form data 4108 and the client authorization field data 4124, the client registration software program 4100 stores a form record identifier 4110, the client registration form data 4108, and the client authorization field data 4124, in a client record 1530 of a client library 1520 in the host server database 1118. The form record identifier 4110 preferably references the form record 1430 that was accessed to present the registration form 4106.

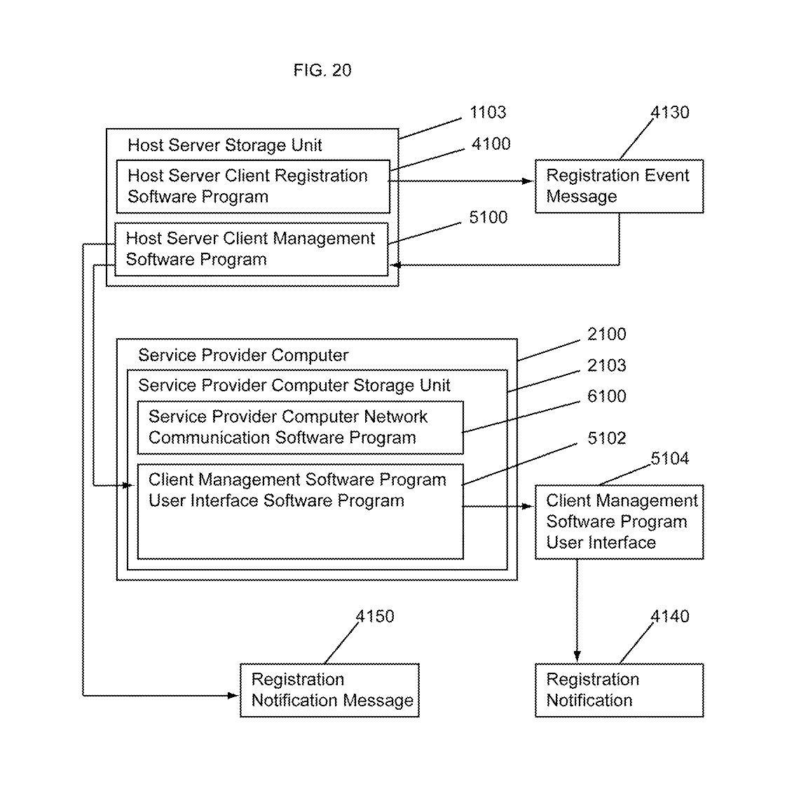

Referring now to FIG. 20, the client registration software program 4100 then preferably sends a registration event message 4130 to the client management software program 5100. The registration event message 4130 preferably includes at least one of (1) an indication that a client registration has been completed, and (2) details about the completed registration.

The client management software program 5100 preferably receives the registration event message 4130 and uses the client management software program user interface software program 5102 to present through the client management software program user interface 5104 a registration notification 4140 to the user of the service provider computer 2100. Preferably, the client management software program 5100 also sends a registration notification message 4150 to an electronic address of a service provider representative.

Preferably, if applicable for certain purposes and/or industries, such as, for example, the medical industry, the present invention includes a client insurance coverage verification feature.

Because a client's data collection form may be submitted in some cases months before the encounter with the service provider, the system preferably verifies the client's insurance coverage, preferably on at least two instances: Upon (1) completion/submission of the client's data collection form, and/or (2) retrieval of the client's insurance information just prior to and/or at the time of the scheduled appointment by the service provider's office staff. Preferably, this enables the service provider to verify that the client's insurance coverage has not changed and/or lapsed since the submission of the client's data for registration.

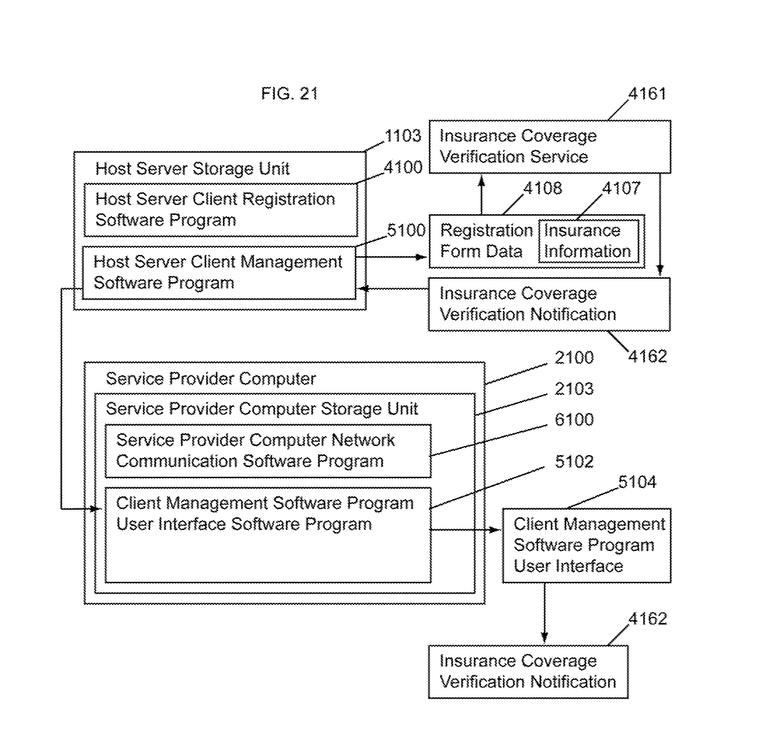

Accordingly with regard to insurance coverage verification being undertaken upon completion/submission of the client's data collection form, and referring now to FIG. 21, preferably, the client management software program 5100 verifies insurance coverage of the client, preferably by sending insurance information 4107 from the registration form data 4108 (for example, for embodiments of the present invention in which insurance information 4107 is collected from a client during completion of the data collection form and made part of the registration form data 4108) to an insurance coverage verification service 4161 (for example, Emdeon, Availity, etc.), and receiving an insurance coverage verification notification 4162 from the insurance coverage verification service 4161.

The client management software program user interface 5104 then preferably presents the insurance coverage verification notification 4162 to the user of the service provider computer 2100.

Preferably, the present invention includes a Portable Document Format (PDF) formatting feature that generates a PDF formatted version of the registration form.

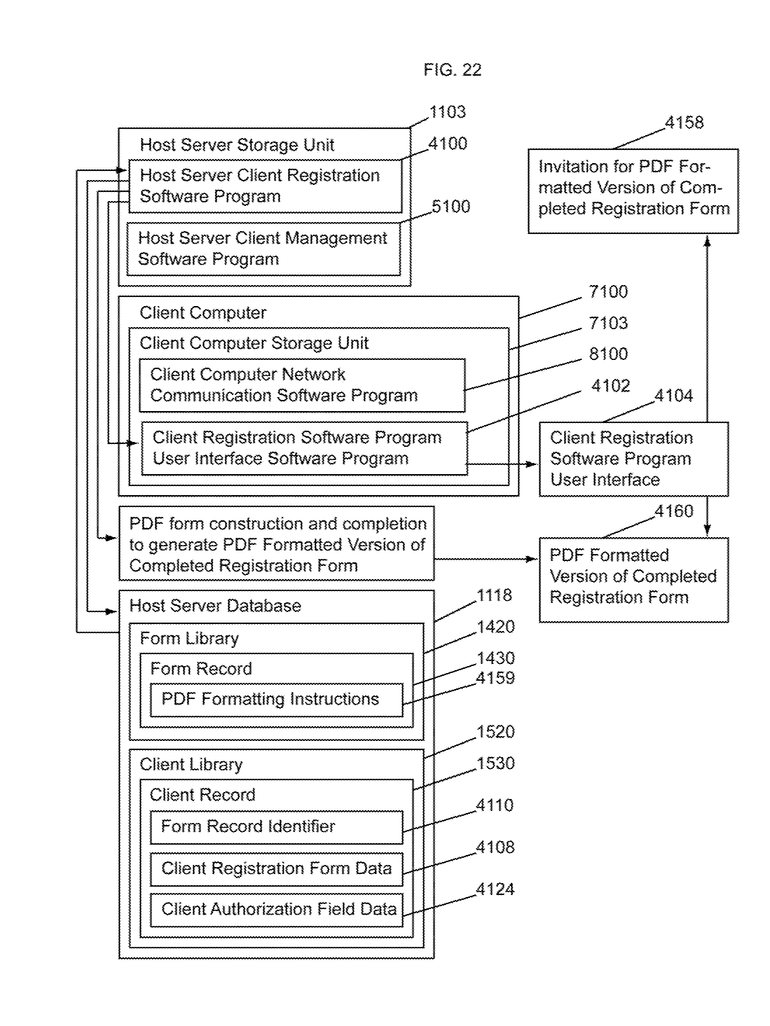

Accordingly, and referring now to FIG. 22, the client registration software program user interface 4104 preferably presents to the user of the client computer 7100 an invitation 4158 to be provided with a PDF formatted version of the completed registration form 4160. When the invitation is accepted, the client registration software program 4100 preferably accesses the client record 1530 to retrieve the form record identifier 4110, the client registration form data 4108, and the client authorization field data 4124 from the client record 1530. The client registration software program 4100 preferably uses the form record identifier 4110 to access the form record 1430 and PDF formatting instructions 4159 stored in the form record 1430.

The client registration software program 4100 then preferably constructs a PDF form using the PDF formatting instructions 4159, and fills the PDF form with the client registration form data 4108 and the client authorization field data 4124 to generate the PDF formatted version of the completed registration form 4160. The client registration software program user interface 4104 then preferably presents the PDF formatted version of the completed registration form 4160 to the user of the client computer 7100.

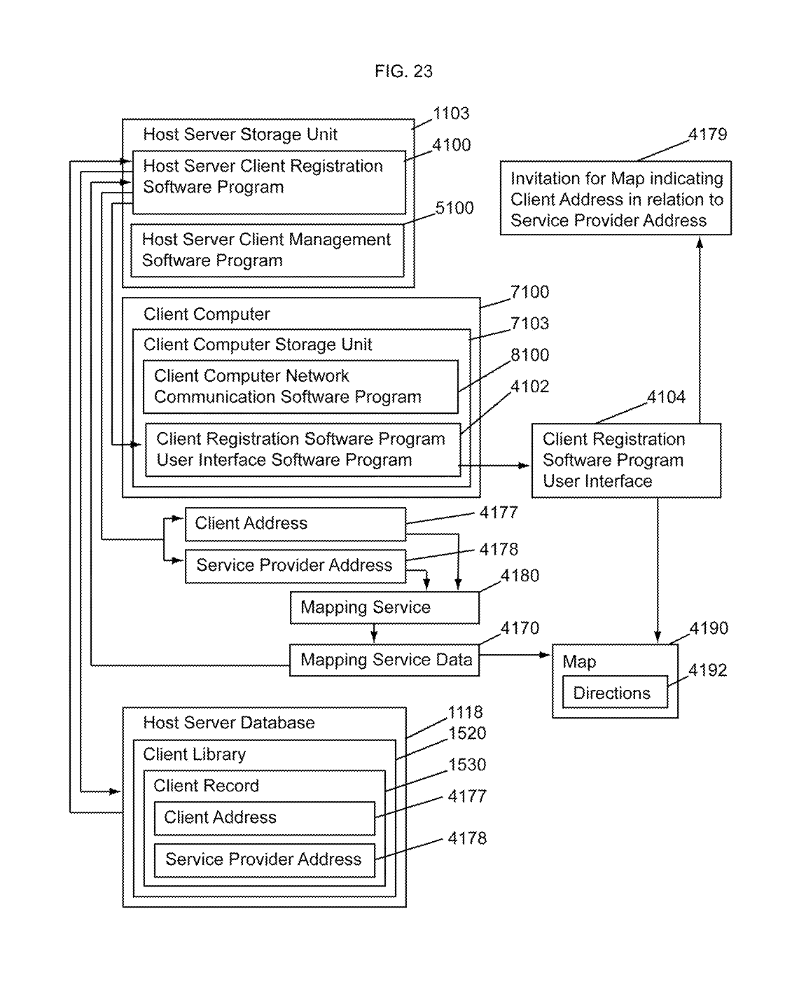

Referring now to FIG. 23, the client registration software program user interface 4104 preferably presents to the user of the client computer 7100 an invitation 4179 to be provided with a map indicating a location of a client address 4177 (for example, for embodiments of the present invention in which the client address 4177 is collected from a client during completion of the data collection form and made part of the registration form data 4108) in relationship to a location of a service provider address 4178. When the invitation 4179 is accepted, the client registration software program 4100 preferably accesses the client record 1530 to retrieve the client address 4177 and the service provider address 4178. The client registration software program 4100 preferably sends the client address 4177 and the service provider address 4178 to a mapping service 4180 (for example, Google, Yahoo, and the like), and accordingly preferably receives from the mapping service 4180 mapping service data 4170. The client registration software program 4100 then preferably uses the mapping service data 4170 to cause the user interface 4104 to present a map 4190 indicating the locations of the addresses. Preferably, the map 4190 also indicates directions 4192 for traveling between the addresses.

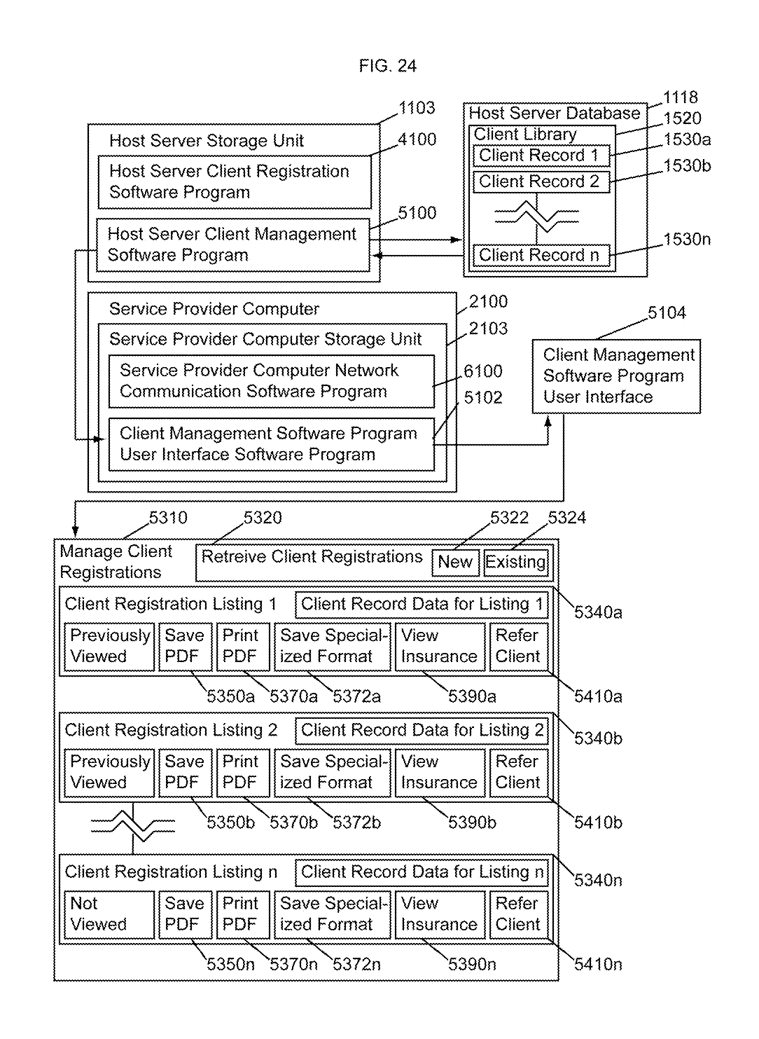

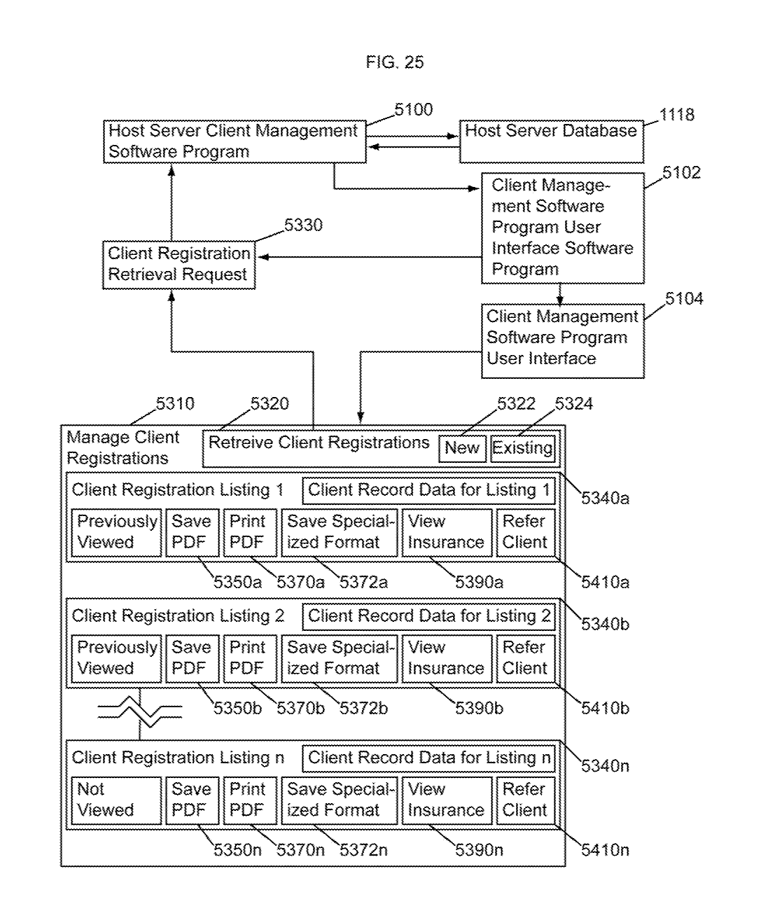

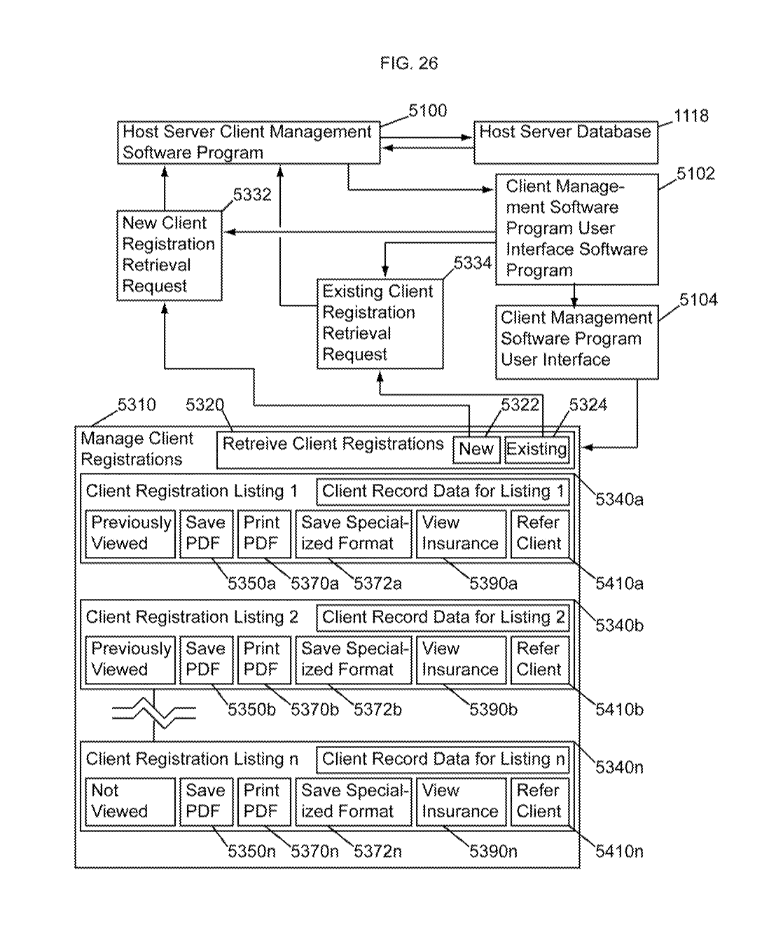

Referring now to FIGS. 24, 25, and 26, the client management software program user interface 5104 preferably presents a client registration management interface 5310 (for example, at a “Patient Registration” tab). The client registration management interface 5310 preferably includes a client registration retrieval device 5320.

Preferably, the client registration retrieval device 5320 preferably includes a new client registration retrieval device 5322 (for example, at a “New” tab at, or a “New” item in a drop down menu under, the “Patient Registration” tab) and an existing client registration retrieval device 5324.

When the client registration retrieval device 5320 is activated, the service provider computer 2100 preferably sends to the client management software program 5100 a client registration retrieval request 5330.

Preferably, when the new client registration retrieval device 5322 is activated, the service provider computer 2100 sends to the client management software program 5100 a new client registration retrieval request 5332. Preferably, when the existing client registration retrieval device 5324 is activated, the service provider computer 2100 sends to the client management software program 5100 an existing client registration retrieval request 5334.

The client management software program 5100 preferably receives the client registration retrieval request 5330 and preferably in response, accesses the client library 1520 in the host server database 1118 and preferably identifies client records 1530 associated with the service provider. Preferably, each client record 1530 includes a service provider identifier and/or a form record identifier 4110, and/or each form record 1430 is associated with at least one service provider. For example, preferably additionally or alternatively, form record 1430 includes one or more service provider identifiers, and/or each service provider account includes one or more form record identifiers 4110. Preferably, the client records 1530 associated with the service provider are identified using one or more of these and/or similar association identifiers. Additionally or alternatively, access, to client records 1530 and/or form records 1430, for each associated service provider preferably can be established using a permissions framework, such as, for example, setting file access permissions, account access permissions, and the like.

The client management software program 5100 then preferably sends data in those client records 1530 to the service provider computer 2100 and the client registration management interface 5310 preferably presents, for each of those client records 1530, a respective client registration listing 5340 that preferably includes the data in the client record 1530. Preferably, each client registration listing 5340 preferably includes one or more of the following data: form record identifier 4110, form name (preferably, for example, a human-readable name established by the form author (for example, physician) during form creation), PDF number (preferably, for example, an identifier identifying the collected client data (for example, preferably, whether or not complete), and further preferably, for example, this identifier is a combination of a service provider group identifier (for example, a physician practice identifier, for example, 01234) and a registration number that is progressive and/or chronological (for example, −1, −2, −3, etc.), such that preferred combinations would be, for example, 01234−1, 01234−2, 01234−3, etc.; preferably, the PDF number, and/or another data item, indicates that the form is (or is not) complete), type of form (preferably, for example, the type identifies the service provider specialty for which the form is used (for example, cardiology), the type of data that the form is designed to be used to collect (for example, pain evaluation data), and/or the source and/or author of the form (for example, Emdeon)), date completed (preferably, for example, this indicates that the form is completed, and therefore, for example, closed to additional data input (for example, for scenarios in which it is important to establish final data, such as, for example, in the medical industry, the client (for example, patient) can be prevented from adding data after the form has been relied upon by a service provider (for example, physician) as containing complete data)), time completed, and date deleted (for example, or a time interval that indicates when it will be deleted (for example, 90 days after completion)).

Preferably, each client registration listing 5340 associated with a client record 1530 that has been created but not previously viewed is presented by the client registration management interface 5310 separately from (and/or otherwise presented differently than) client registration listings 5340 associated with client records 1530 that have been created and previously viewed.

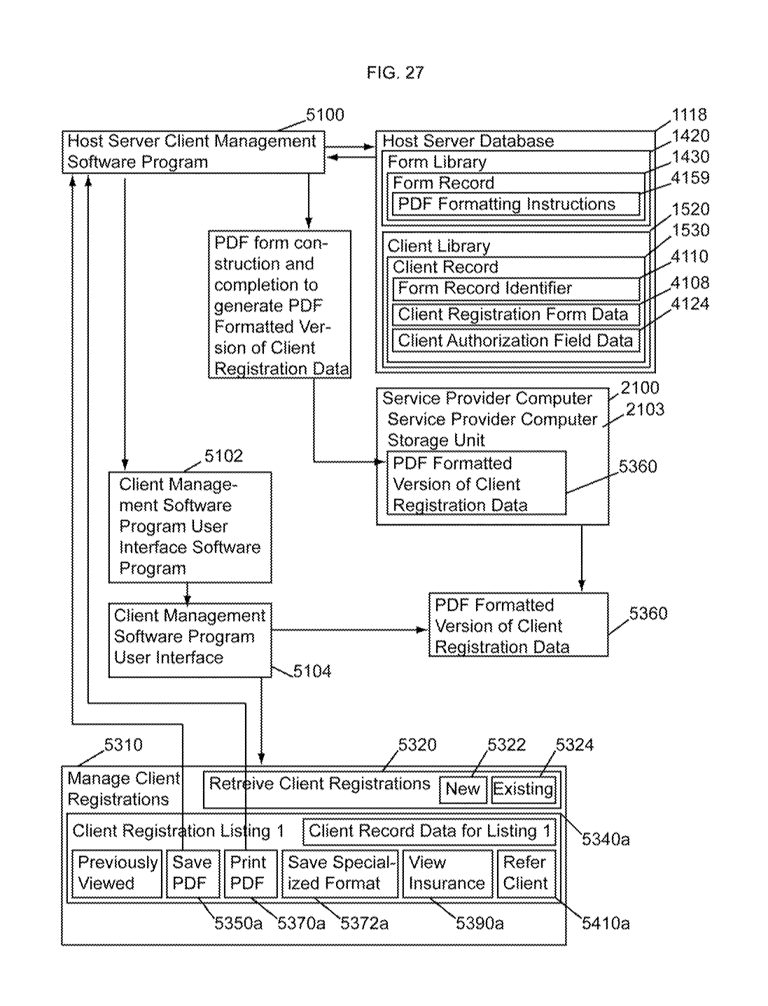

Referring now also to FIG. 27, in association with each client registration listing 5340, the client registration management interface 5310 preferably presents a PDF save device 5350. When the PDF save device 5350 is activated, the client management software program 5100 preferably accesses the associated client record 1530 to retrieve the form record identifier 4110, the client registration form data 4108, and the client authorization field data 4124 from the client record 1530. The client management software program 5100 preferably uses the form record identifier 4110 to access the form record 1430 and the PDF formatting instructions 4159 stored in the form record 1430.

The client management software program 5100 then preferably constructs a PDF form using the PDF formatting instructions 4159, and fills the PDF form with the client registration form data 4108 and the client authorization field data 4124 to generate a PDF formatted version of the client registration data 5360. The client management software program 5100 then preferably stores the PDF formatted version of the client registration data 5360 on the service provider computer 2100. The client registration management interface 5310 then preferably presents the PDF formatted version of the client registration data 5360.

The client registration management interface 5310 then preferably presents a PDF print device 5370. When the PDF print device 5370 is activated, the client management software program user interface software program 5102 preferably instructs the service provider computer 2100 to print the PDF formatted version of the client registration data 5360.

In addition or alternatively to providing PDF generation of the registration form and/or collected data, the present invention preferably allows client data and/or registration information to be exported to other systems, including, but not limited to, data management systems and data processing systems. Regarding the medical industry, this preferably includes, but is not limited to, one or more of the following: various EMR, EHR, PHR, and PMS systems. The present invention preferably integrates with these systems, preferably by outputting and/or exporting client data and/or registration information in a format and/or layout accepted by these systems. Industry standard methods, protocols, and/or forms of transmitting client data into an EMR or other client data storage and/or processing system include, but are not limited to, one or more of the following: HL7, CSV, XML, CCD, and/or CCR.

Accordingly, the present invention preferably allows a service provider to import (or, for example, export or, for example, otherwise transfer or have transferred) a client's data and/or registration information into the service provider's EMR (or other client data storage and/or processing system), preferably via one or more of the following, depending on the system the service provider uses: (1) a Health Level Seven International (HL7) interface, (2) a document formatted in a Comma Separated Values (CSV) format, (3) a document formatted in a customized Extensible Markup Language (XML) format, (4) a Continuity of Care Document (CCD), and/or (5) a Continuity of Care Record (CCR) using the CCR standard. Preferably, to do so, the service provider can choose the client record to import (or, for example, export or, for example, otherwise transfer or have transferred) from a list provided by the data management system, and select the appropriate HL7, CSV, XML, CCD, and/or CCR related icon.

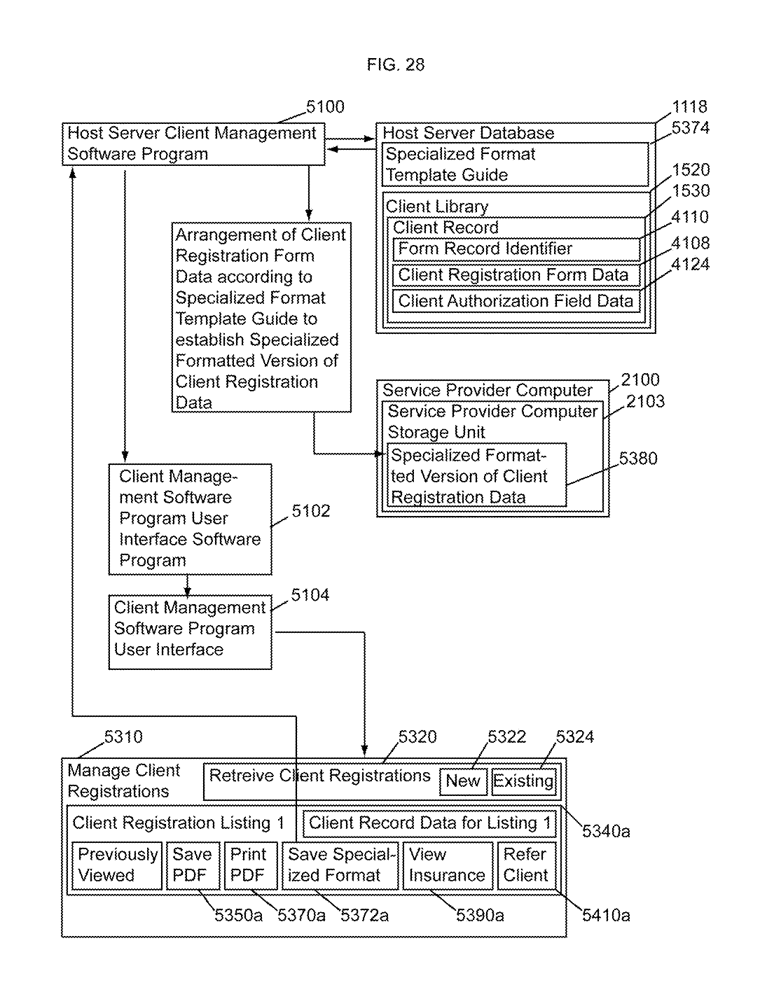

Accordingly, more specifically, and referring now also to FIG. 28, preferably, in embodiments in which the service provider computer 2100 stores client registration form data 4108 in a specialized format (for example, an HL7, CSV, XML, CCD, and/or CCR format), the client registration management interface 5310 preferably presents a specialized format save device 5372. When the specialized format save device 5372 is activated, the client management software program 5100 preferably accesses the associated client record 1530 to retrieve the form record identifier 4110 and the client registration form data 4108 from the client record 1530, and preferably additionally accesses a specialized format template guide 5374 (for example a database of formatting guidelines for versions of accepted formats, such as, for example, HL7, CSV, XML, CCD, and/or CCR formats). The client management software program 5100 then preferably arranges the client registration form data 4108 according to the specialized format template guide 5374 to establish a specialized formatted version of the client registration data 5380. The client management software program 5100 then preferably stores the specialized formatted version of the client registration data 5380 on the service provider computer 2100.

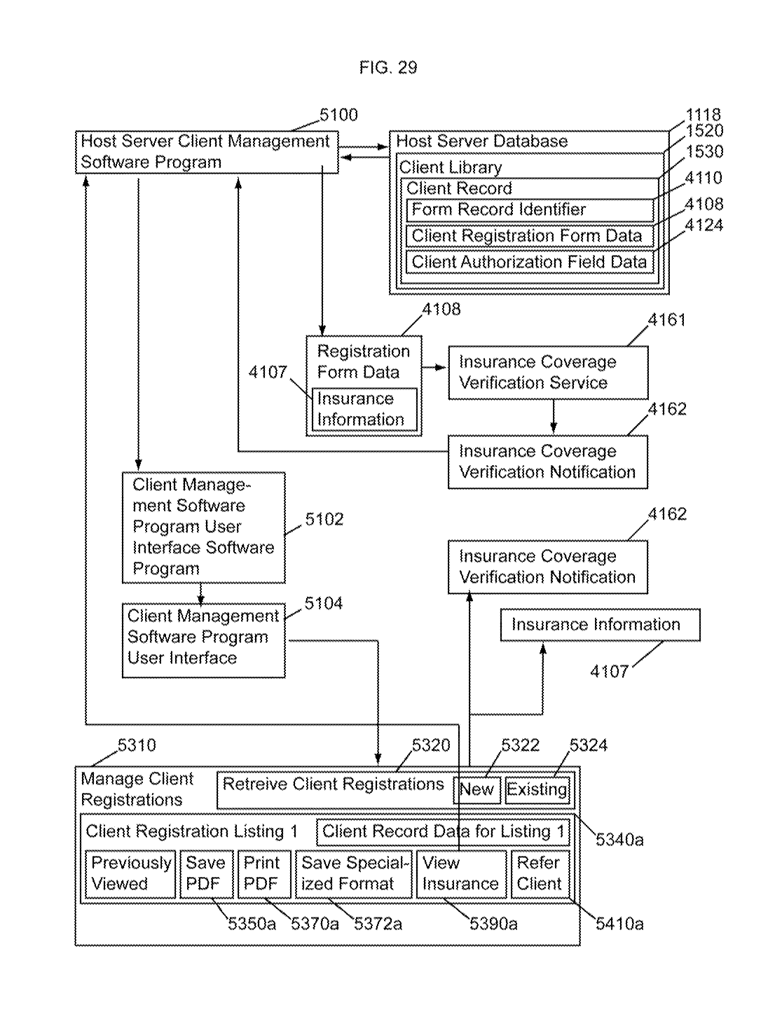

Further, as noted above with regard to insurance verification, preferably, insurance coverage verification is additionally or alternatively undertaken just prior to and/or at the time of the scheduled appointment by the service provider's office staff. Accordingly, and referring now also to FIG. 29, further in association with each client registration listing 5340, the client registration management interface 5310 preferably presents a view client insurance device 5390. When the view client insurance device 5390 is activated, the client management software program 5100 preferably accesses the associated client record 1530 to retrieve the form record identifier 4110 and the client registration form data 4108 from the client record 1530. The client management software program 5100 then preferably verifies the insurance coverage of the client, preferably by sending the insurance information 4107 from the registration form data 4108, when the form data preferably includes insurance information 4107, to the insurance coverage verification service 4161, and receiving an insurance coverage verification notification 4162 from the insurance coverage verification service 4161. The client registration management interface 5310 then preferably presents the insurance information 4107 from the registration form data 4108 and the insurance coverage verification notification 4162.

It should be understood that with regard to the collection and storage of client data by the present invention, the present invention contemplates that form data sets can be partially completed by a client, stored, and then later retrieved and further completed, and then stored again, etc., until fully completed. This is useful, for example, in cases in which a client has time limitations for the completion of a registration form, and/or must complete a portion of the form initially, and then the remainder of the form at a different time or at different times.

It should further be understood that complete and incomplete data collection forms that contain data entered by clients preferably can be arranged, organized, and retrieved by service providers using the present invention.

Preferably, the present invention enables service providers to refer clients to other service providers. For example, service providers (for example, health care providers) often will refer their clients to other service providers (for example, to health care specialists who deal with a certain type of illness or disease category exclusively).

Accordingly, preferably using a referral feature of the present invention, service providers preferably can create their own network of partner service providers (for example, partner health care providers) to whom they frequently and/or commonly refer clients (for example, patients). Once a network is created, a service provider preferably can utilize the present invention's client referral feature to send the client's data and/or registration information, preferably along with any other necessary records, to the referral service provider.

Service providers that are not using a data management system of the present invention preferably can be invited to sign up to use the data management system of the present invention, preferably free of charge if desired, and preferably then (once signed up) receive the complete data and/or registration information of the referred client. With a preferably quick and preferably free (if desired) trial account setup, the referral service provider preferably will be able to access the full data and/or registration information of the referred client. It is contemplated by the present invention that this aspect of the present invention preferably is a viral growth feature that, for example, facilitates a rapid increase in knowledge and usage of the system throughout an industry or industries.

Preferably, the referral process includes the following steps, however, it should be understood that more or fewer steps are also contemplated, and that all manner of step ordering permutations are contemplated.

In some embodiments, the service provider preferably: logs into the system; selects a device that indicates that selecting the device will enable the service provider to refer a client; is presented with a list of clients that can be referred; selects one of the clients for referral; is presented with a list of service providers to which the selected client can be referred; and selects a service provider from the list.

Alternatively in some embodiments, the service provider preferably: logs into the system; is presented with a list of clients that can be referred; is presented with, in connection with each of the client names, a device that indicates that selecting the device will enable the service provider to refer the respective client; decides which client the service provider desires to refer and selects the device in connection with the name of the client; is presented with a list of service providers to which the selected client can be referred; and selects a service provider from the list.

Preferably after selecting the referral service provider, the referring service provider is presented with one or more devices using which the provider can (1) add or attach a description of the client's issue or concern (for example, a diagnosis), (2) enter or attach a note (for example, up to a specified number of characters in length), and (4) attach any necessary records (for example, documents, images, videos, or other record items). The referring service provider preferably is then able to initiate the sending of the referral information (for example, click a “Send” device). The client's data collection (for example, registration) information preferably is automatically included in the referral transmission.

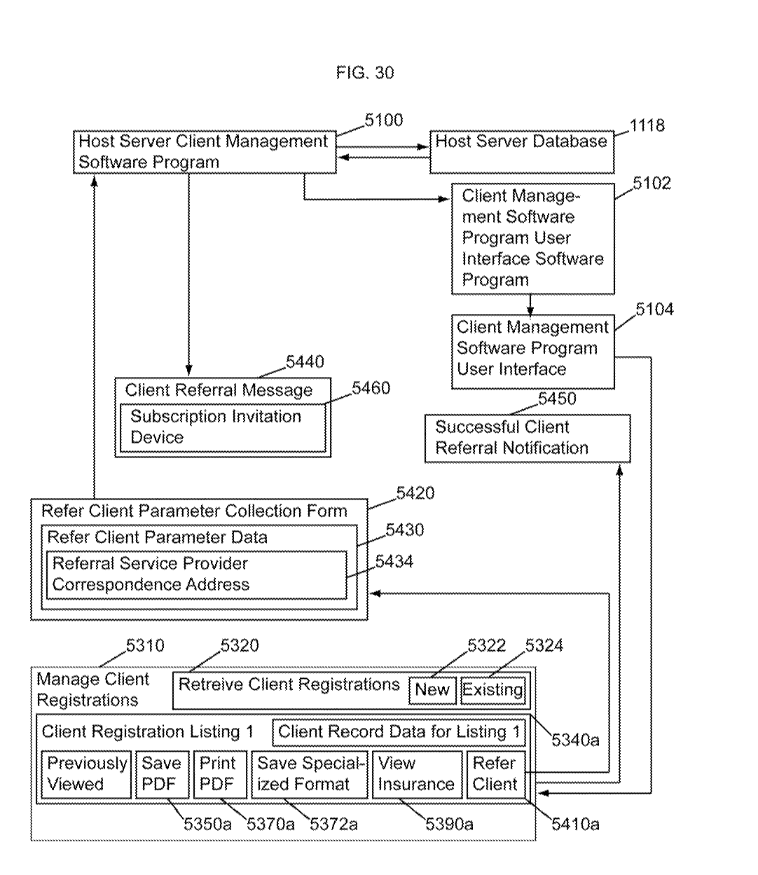

Accordingly, and more specifically as to preferred embodiments, referring now also to FIG. 30, further in association with each client registration listing 5340 that has not been deleted or already referred, the client registration management interface 5310 preferably presents a refer client device 5410. When the refer client device 5410 is activated, the client registration management interface 5310 preferably presents a refer client parameter collection form 5420. As the user of the service provider computer 2100 completes the refer client parameter collection form 5420, the client management software program 5100 preferably receives refer client parameter data 5430 from the service provider computer 2100. The refer client parameter data 5430 preferably includes one or more of the following: an identification (for example, name) of the service provider to whom the client is being referred, a referral service provider correspondence address 5434 (for example, preferably an electronic mail address) of the service provider to whom the client is being referred, the service reason for the referral (for example, the problem and/or diagnosis), when the client should see the service provider to whom the client is being referred, whether additional information or documents (for example, physician reports, labs, or radiographs) have been sought, applicable notes, and documents (for example, which preferably can be attached and/or uploaded).

Preferably, after the client registration management software program 5100 receives the refer client parameter data 5430 from the service provider computer 2100, the client registration management software program 5100 sends a client referral message 5440 to the referral service provider correspondence address 5434. Then, the client registration management interface 5310 preferably presents a successful client referral notification 5450 indicating that the client referral message 5440 was sent.

The service provider receiving the referral preferably receives a notification of the sent referral, preferably with an option to (1) accept the referral and/or download the client data and/or registration information and/or form, and/or (2) create an account (preferably free of charge, if desired) if the service provider does not have an account (establishing an account preferably allows the service provider to then view the client data and/or registration information and/or form). Preferably, if the service provider receiving the referral accepts the referral, the service provider preferably is enabled to contact the client to confirm the appointment date and time if the service provider chooses to do so.

Accordingly, and more specifically as to a preferred embodiment, if the referral service provider (the service provider to whom the client is being referred) is not a service provider subscribed to the client registration management system, the client referral message 5440 preferably includes (1) an identification of the referring service provider; (2) an explanation that the referring service provider has referred a client using the client registration management system and that in order to accept the referral and other referrals, the referral service provider must subscribe to the client registration management system; and (3) a subscription invitation device 5460. Preferably, when the subscription invitation device 5460 is activated, a subscription process is initiated whereby the referral service provider is able to subscribe to the client registration management system.

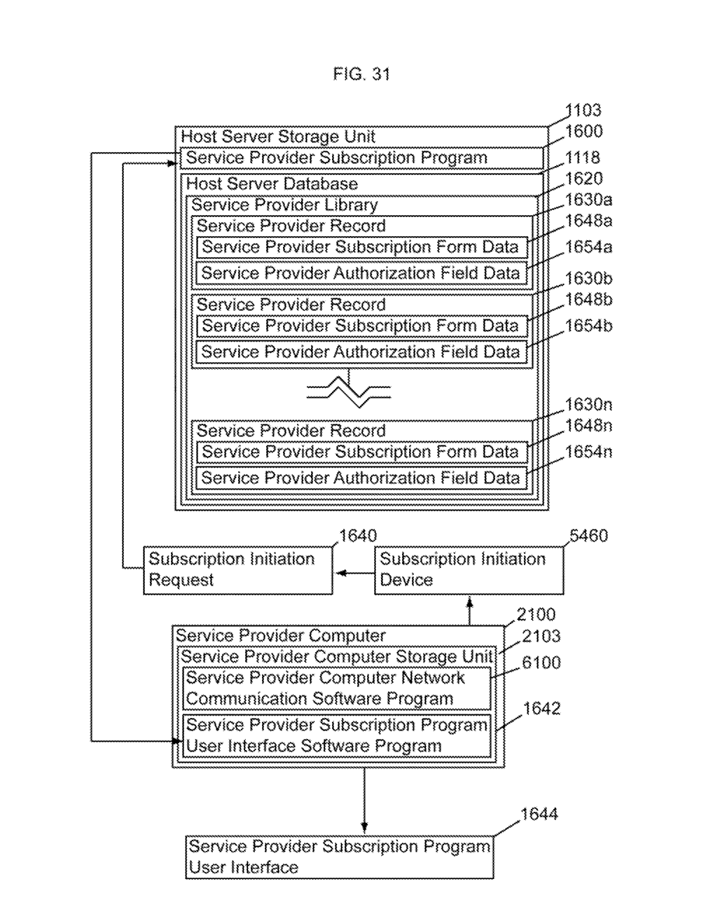

Referring now to FIG. 31, more particularly, the host server storage unit 1103 preferably includes a service provider subscription program 1600 that preferably can be executed by the processor unit 1101 and access the memory unit 1102 and the storage unit 1103. The host server database 1118 of the storage unit 1103 further preferably includes a service provider library 1620. The service provider library 1620 preferably includes a plurality of service provider records 1630.

When activated, the subscription invitation device 5460 preferably sends to the service provider subscription program 1600, and the service provider subscription program 1600 preferably receives from the service provider computer 2100 of the referral service provider, a subscription initiation request 1640. The service provider subscription program 1600 preferably sends to the service provider computer 2100 of the referral service provider a service provider subscription program user interface software program 1642 that preferably can be executed by the network communication software program 6100 of the service provider computer 2100 of the referral service provider. During execution, the user interface software program 1642 preferably presents a service provider subscription program user interface 1644. By way of the user interface 1644, the service provider subscription program 1600 preferably receives input from, and sends output to, a user of the service provider computer 2100 of the referral service provider.

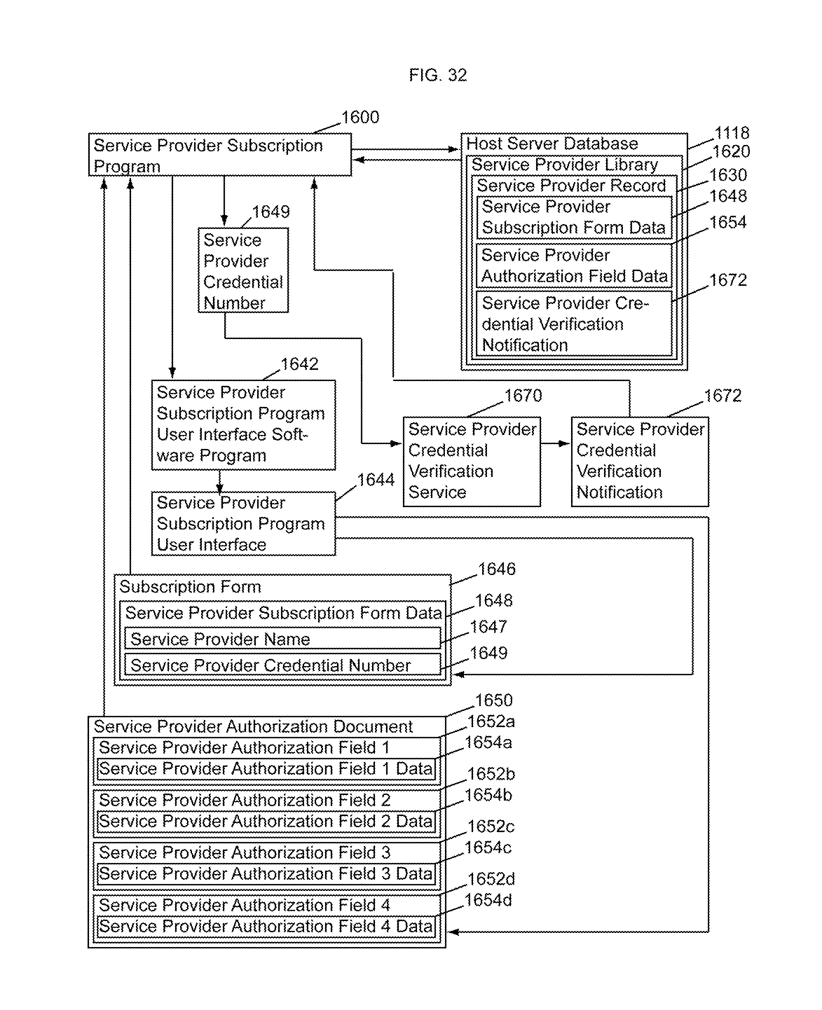

Referring now also to FIG. 32, the service provider subscription program 1600 preferably instructs the user interface software program 1642 to cause the user interface 1644 to present to the user of the service provider computer 2100 of the referral service provider a subscription form 1646.

As the user of the service provider computer 2100 of the referral service provider completes the subscription form 1646 using the user interface 1644, the service provider subscription program 1600 preferably receives service provider subscription form data 1648 from the service provider computer 2100 of the referral service provider. The service provider subscription form data 1648 preferably includes one or more of the following: (1) service provider name 1647, (2) service provider company name (for example, practice name), (3) service provider company location (for example, practice location), (4) service provider credential number 1649 (for example, National Provider Identifier (NPI) number), (5) service provider payment information, and (6) acceptance of subscription terms and conditions.

The user interface 1644 preferably presents to the user of the service provider computer 2100 of the referral service provider at least one service provider authorization document 1650. The at least one service provider authorization document 1650 preferably includes a business associate agreement (for example, for HIPAA compliance purposes).

Each service provider authorization document 1650 preferably includes at least one respective service provider authorization field 1652. The at least one respective service provider authorization field 1652 preferably includes one of more of the following fields: (1) name of the service provider providing authorization, (2) Internet (or other network) protocol address of the computer used to provide authorization, (3) date the authorization was provided, and (4) time the authorization was provided.

When the user of the service provider computer 2100 of the referral service provider completes the service provider authorization field 1652 for each of the service provider authorization documents 1650, the service provider subscription program 1600 preferably receives service provider authorization field data 1654 from the service provider computer 2100 of the referral service provider. The service provider authorization field data 1654 preferably includes data for each service provider authorization field 1652. The service provider authorization field data 1654 accordingly preferably includes at least one of the following: (1) name of the service provider, (2) Internet (or other network) protocol address of the service provider computer 2100 of the referral service provider, (3) date the service provider authorization field data 1654 was provided, and (4) time the service provider authorization field data 1654 was provided.

Preferably, once the service provider subscription program 1600 receives the service provider subscription form data 1648 and the service provider authorization field data 1654, the service provider subscription program 1600 stores the service provider subscription form data 1648 and the service provider authorization field data 1654 in a service provider record 1630 of the service provider library 1620 in the host server database 1118.

Preferably, the service provider subscription program 1600 further verifies the service provider credential number 1649, preferably by sending the service provider name 1647 and the service provider credential number 1649 to a service provider credential verification service 1670, and receiving a service provider credential verification notification 1672 from the service provider credential verification service 1670.

The service provider subscription program 1600 preferably stores the service provider credential verification notification 1672 in the service provider record 1630.

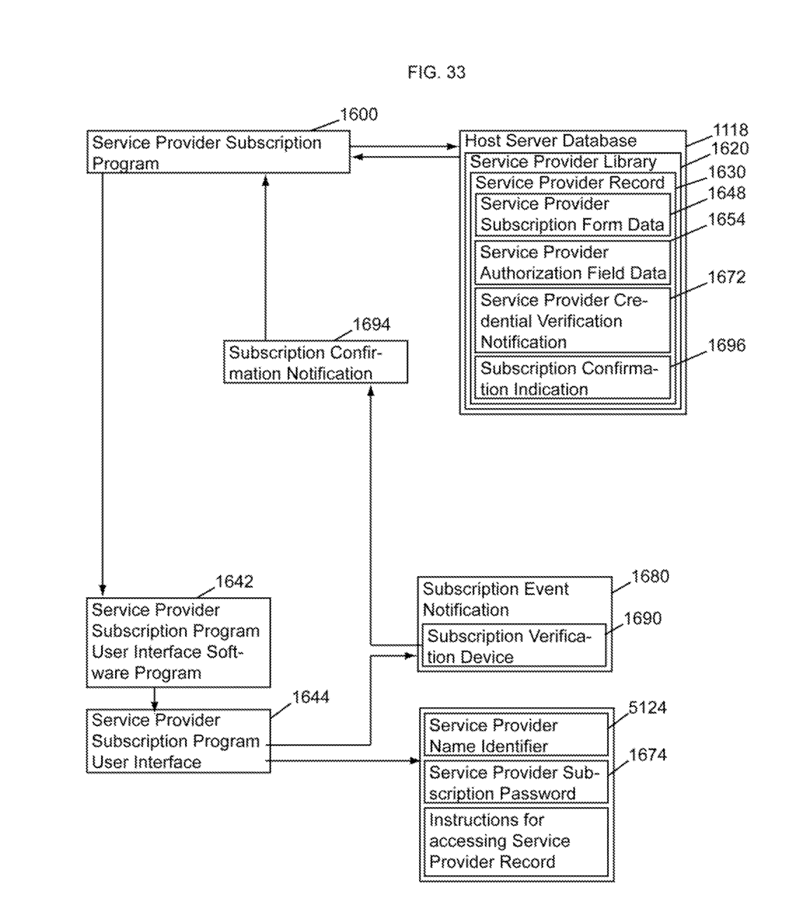

Referring now also to FIG. 33, the service provider subscription program 1600 then preferably assigns a service provider subscription password 1674 to the service provider's account. Preferably, to provide a service provider access to the service provider's account, the service provider name identifier 5124 and the service provider subscription password 1674 must be received by the service provider subscription program 1600. The service provider subscription program 1600 then preferably instructs the user interface software program 1642 to cause the user interface 1644 to present to the user of the service provider computer 2100 of the referral service provider the service provider name identifier 5124 and the service provider subscription password 1674. Preferably, the presentation of the service provider name identifier 5124 and the service provider subscription password 1674 is accompanied by instructions for using the service provider name identifier 5124 and the service provider subscription password 1674 to access the service provider's account.

The service provider subscription program 1600 then preferably uses the service provider subscription program user interface software program 1642 to present through the service provider subscription program user interface 1644 a subscription event notification 1680 to the user of the service provider computer 2100 of the referral service provider. The subscription event notification 1680 preferably includes at least one of (1) an indication that a service provider subscription has been completed, (2) details about the completed subscription, and (3) a subscription verification device 1690. When activated, the subscription verification device 1690 preferably sends to the service provider subscription program 1600 a subscription confirmation notification 1694. Upon receipt of the subscription confirmation notification 1694, the service provider subscription program 1600 preferably stores in the service provider record 1630 a subscription confirmation indication 1696 and the service provider subscription is completed.

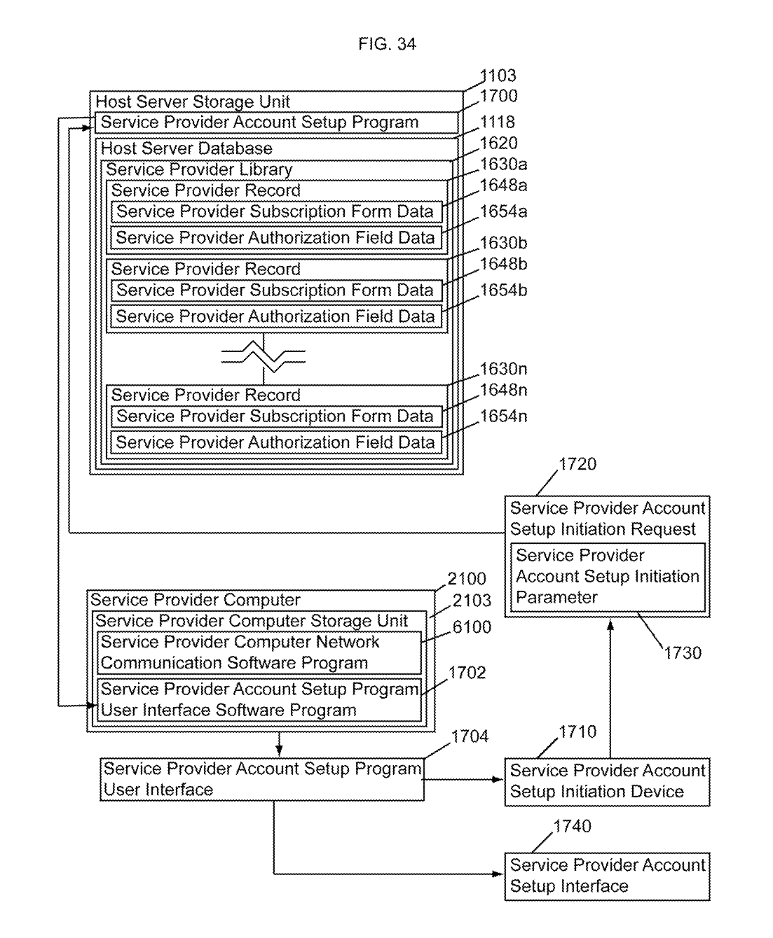

Referring now to FIG. 34, preferably, after the service provider subscription process is completed, a service provider account setup process is initiated. More particularly, the host server storage unit 1103 preferably includes a service provider account setup program 1700 that preferably can be executed by the processor unit 1101 and access the memory unit 1102 and the storage unit 1103. During execution, the service provider account setup program 1700 preferably sends to the service provider computer 2100 of the referral service provider a service provider account setup program user interface software program 1702 that preferably can be executed by the network communication software program 6100. During execution, the user interface software program 1702 preferably presents a service provider account setup program user interface 1704. By way of the user interface 1704, the service provider account setup program 1700 preferably receives input from a user of the service provider computer 2100 of the referral service provider, and sends output to the user of the service provider computer 2100 of the referral service provider.

Upon completion of the service provider subscription process, the service provider account setup program 1700 preferably instructs the user interface software program 1702 to cause the user interface 1704 to present to the user of the service provider computer 2100 of the referral service provider a service provider account setup initiation device 1710. When activated, the service provider account setup initiation device 1710 preferably sends to the service provider account setup program 1700 a service provider account setup initiation request 1720. The service provider account setup initiation request 1720 preferably includes at least one service provider account setup initiation parameter 1730. Preferably, the at least one service provider account setup initiation parameter 1730 includes one or more of the following: (1) the service provider name identifier 5124, and (2) the service provider subscription password 1674. More particularly, preferably, by way of the service provider account setup initiation device 1710, the user of the service provider computer 2100 of the referral service provider preferably provides to the service provider account setup program 1700, and the service provider account setup program 1700 preferably receives from the user of the service provider computer 2100 of the referral service provider, the at least one service provider account setup initiation parameter 1730.

After receiving the at least one service provider account setup initiation parameter 1730, the service provider account setup program 1700 preferably matches the at least one service provider account setup initiation parameter 1730 to the service provider's service provider record 1630 of the service provider library 1620 in the host server database 1118. The service provider account setup program 1700 then preferably instructs the user interface software program 1702 to cause the user interface 1704 to present to the user of the service provider computer 2100 of the referral service provider a service provider account setup interface 1740.

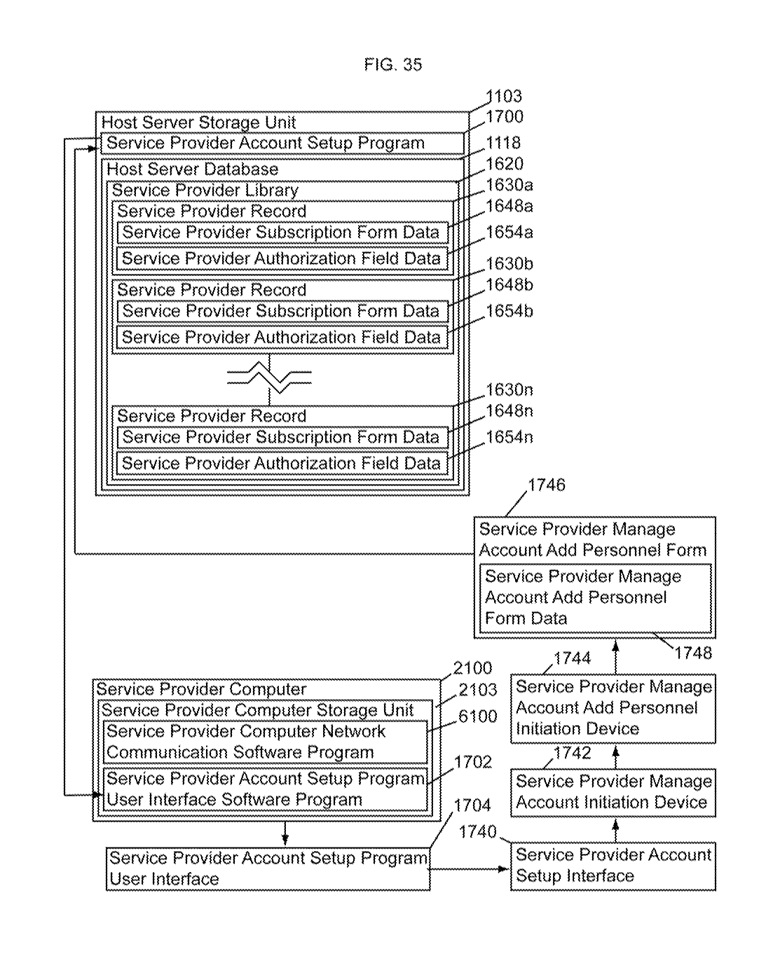

Referring now also to FIG. 35, the service provider account setup interface 1740 preferably includes a service provider manage account initiation device 1742. When the service provider manage account initiation device 1742 is activated, the service provider account setup interface 1740 preferably presents a service provider manage account add personnel initiation device 1744. When the service provider manage account add personnel initiation device 1744 is activated, the service provider account setup interface 1740 preferably presents a service provider manage account add personnel form 1746. As the user of the service provider computer 2100 of the referral service provider completes the service provider manage account add personnel form 1746 using the user interface 1704, the service provider account setup program 1700 preferably receives service provider manage account add personnel form data 1748 from the service provider computer 2100 of the referral service provider. The service provider manage account add personnel form data 1748 preferably includes one or more of the following: (1) service provider executive personnel names, credentials, and areas of expertise (for example, names of physicians in the practice, their degrees, and each one's specialty), (2) service provider administrative personnel names and titles (for example, practice staff member names and titles), (3) service provider location addresses, and (4) service provider preferred outsource service providers (for example, preferred referral health care providers). The service provider account setup program 1700 preferably stores the service provider manage account add personnel form data 1748 in the service provider record 1630 of the service provider library 1620 in the host server database 1118.

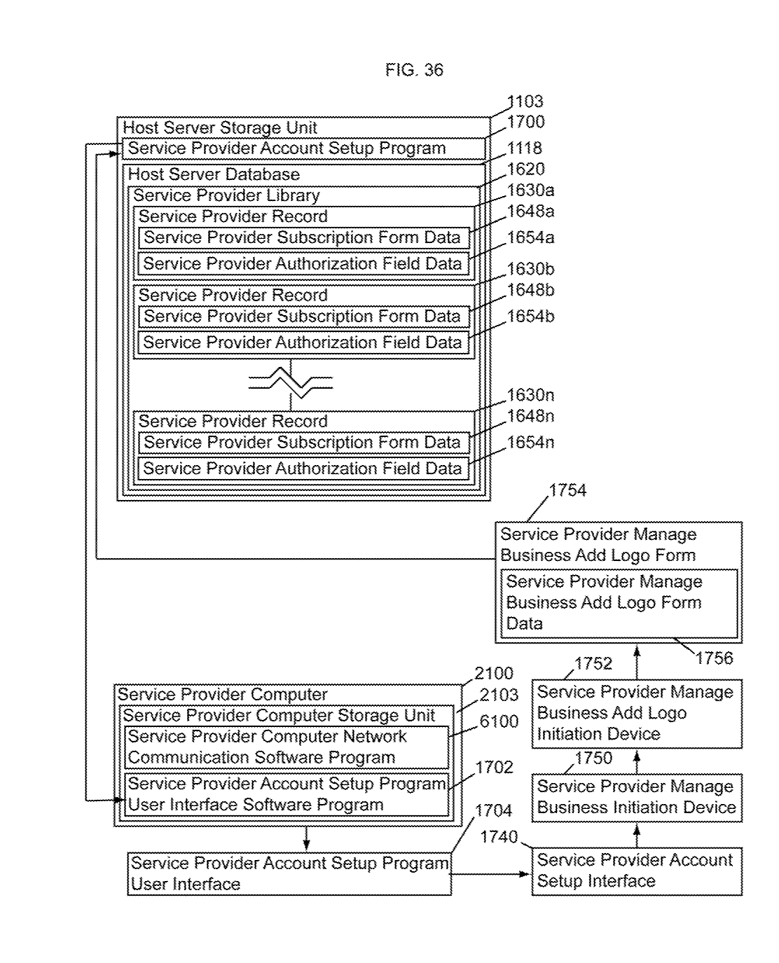

Referring now also to FIG. 36, the service provider account setup interface 1740 further preferably includes a service provider manage business initiation device 1750.

When the service provider manage business initiation device 1750 is activated, the service provider account setup interface 1740 preferably presents a service provider manage business add logo initiation device 1752. (It should be understood that “logo” as used herein preferably encompasses any type of source identifier.) When the service provider manage business add logo initiation device 1752 is activated, the service provider account setup interface 1740 preferably presents a service provider manage business add logo form 1754. As the user of the service provider computer 2100 of the referral service provider completes the service provider manage business add logo form 1754 using the user interface 1704, the service provider account setup program 1700 preferably receives service provider manage business add logo form data 1756 from the service provider computer 2100 of the referral service provider. The service provider manage business add logo form data 1756 preferably includes one or more of the following: (1) a color image of the service provider's business logo, and (2) a greyscale image of the service provider's business logo. The service provider account setup program 1700 preferably stores the service provider manage business add logo form data 1756 in the service provider record 1630 of the service provider library 1620 in the host server database 1118.

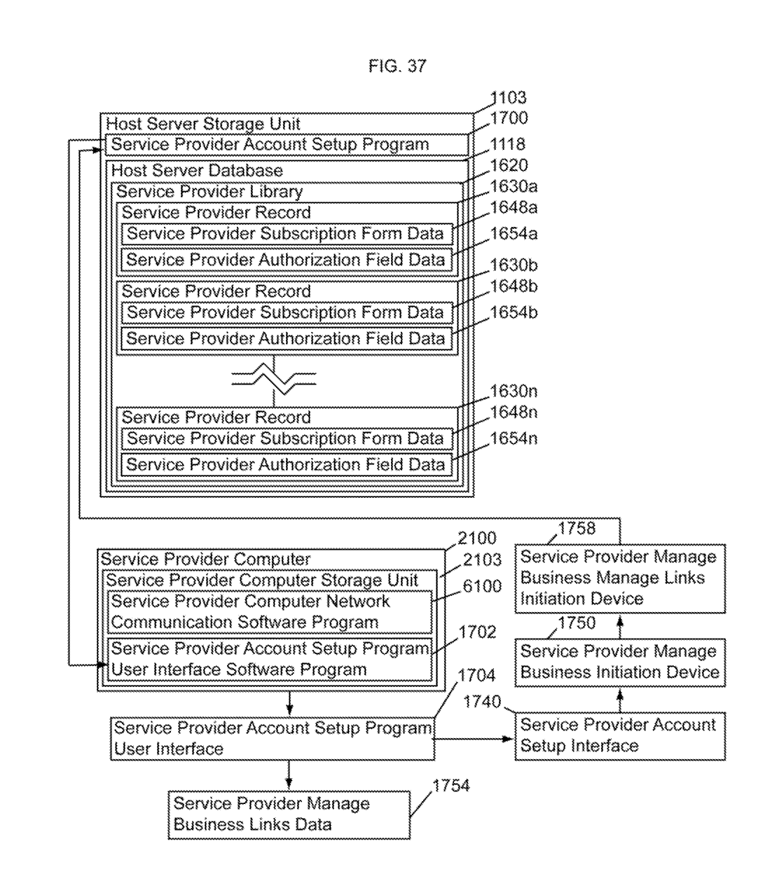

Referring now to FIG. 37, further when the service provider manage business initiation device 1750 is activated, the service provider account setup interface 1740 preferably presents a service provider manage business manage links initiation device 1758. (It should be understood that “links” as used herein preferably encompasses any type of suitable connection mechanism and/or address to a connection and/or connected content.) When the service provider manage business manage links initiation device 1758 is activated, the service provider account setup program 1700 preferably accesses the service provider record 1630 of the service provider library 1620 in the host server database 1118 to obtain service provider manage business links data 1754 and preferably instructs the user interface software program 1702 to cause the user interface 1704 to present to the user of the service provider computer 2100 of the referral service provider the service provider manage business links data 1754. The service provider manage business links data 1754 preferably includes one or more of the following: (1) a link to the service provider's client registration form, (2) a link to the service provider's client record update form, and (3) a link to the service provider's client referral form.

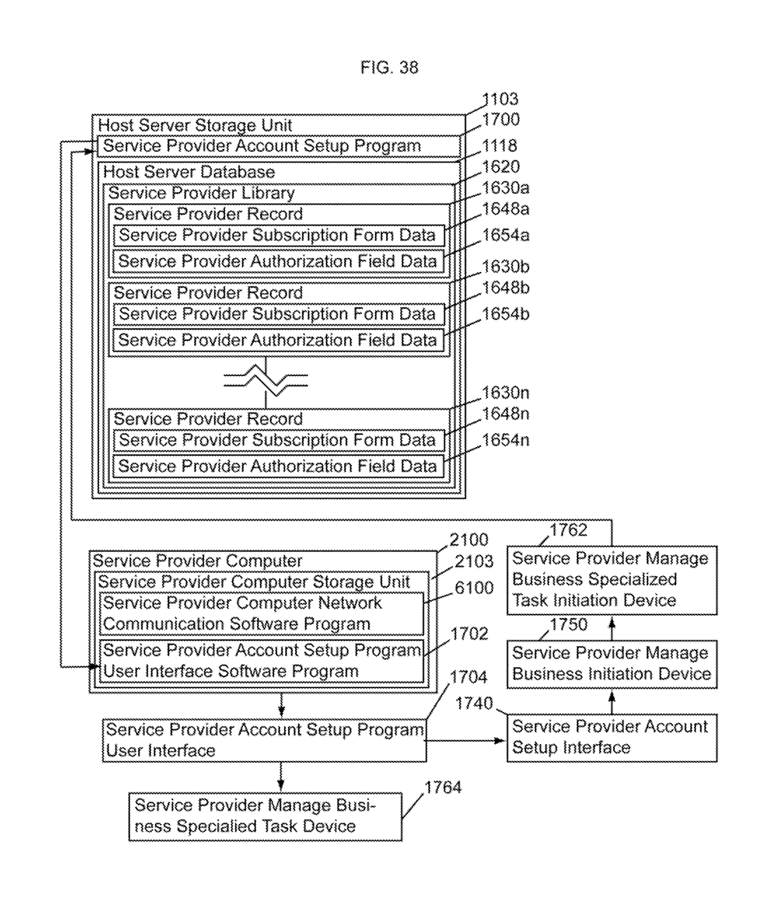

Referring now to FIG. 38, further when the service provider manage business initiation device 1750 is activated, the service provider account setup interface 1740 preferably presents at least one service provider manage business specialized task initiation device 1762. When the service provider manage business specialized task initiation device 1762 is activated, the service provider account setup program 1700 preferably instructs the user interface software program 1702 to cause the user interface 1704 to present to the user of the service provider computer 2100 of the referral service provider at least one service provider manage business specialized task device 1764 that enables associated functionality of the service provider account setup program 1700. The service provider manage business specialized task device 1764 preferably includes one or more of the following: (1) a verify client information device (for example, to verify patient information), (2) an API key generation device (for example, to generate API keys to interface with various practice management tools), (3) an update administration information device (for example, to update administration information), (4) a registration form preference selection device (for example, to choose to receive PDFs in color, greyscale, or black and white), (5) an insurance verification addition device (for example, to choose to add insurance verification page(s) to registration PDFs), and (6) an image upload device (for example, to upload a personal profile picture). It should be understood that preferably, access to the service provider manage business task initiation devices 1762 and related functionality can be managed using permission settings, for example, users preferably can be granted (or not granted) permission by the management system to be able to access (or not be able to access) one or more of the service provider manage business task initiation devices 1762 and related functionalities.

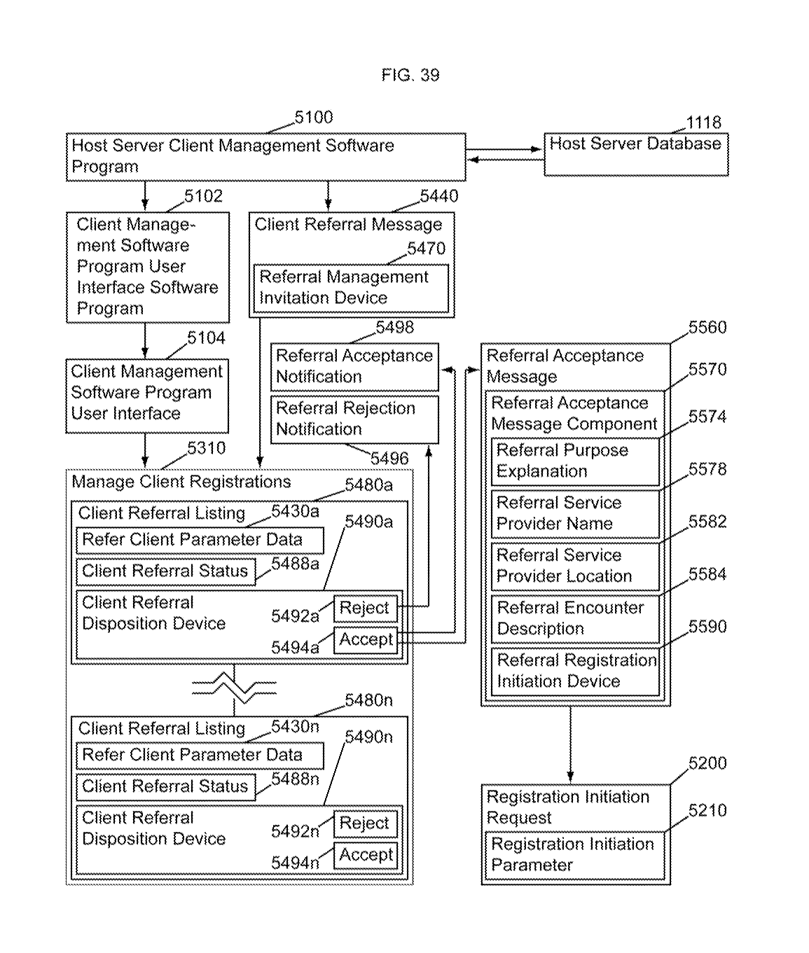

Referring now to FIG. 39, preferably, if the referral service provider (the service provider to whom the client is being referred) is a service provider subscribed to the client registration management system, (a) the client referral message 5440 includes (1) an identification of the referring service provider, (2) an explanation that the referring service provider has referred a client using the client registration management system, and (3) a referral management invitation device 5470. When the referral management invitation device 5470 is activated, the client registration management interface 5310 of the referral service provider preferably presents a client referral listing 5480 that preferably includes the refer client parameter data 5430. Preferably, the client registration management interface 5310 presents, for each client referral not yet accepted or rejected, a client referral listing 5480 that preferably includes respective refer client parameter data 5430.

Preferably, in association with each client referral listing 5480, the client registration management interface 5310 presents a client referral status indicator 5488. Preferably, the client referral status indicator 5488 indicates, for each client referral, whether the client referral has been accepted or rejected.

Preferably, the referring service provider receives confirmation of the referral service provider's choice to either accept or reject the referral. If the service provider receiving the referral accepts it, the client preferably is automatically sent a data collection form (for example, registration form) of/for, and/or suitable for use with, and/or otherwise associated with, that receiving service provider. Preferably, however, in order to avoid the client needing to complete and/or submit some or all of the same client data again, the present invention automatically fills in (for example, auto-populates, pre-populates, and/or maps) any duplicate information from (and/or information determinable based on and/or using information from) the referring service provider's data collection form (for example, registration form) into the new data collection form (for example, registration form).

Preferably, in association with each client referral listing 5480, the client registration management interface 5310 presents a client referral disposition device 5490. Preferably, the client referral disposition device 5490 includes a reject referral device 5492 and an accept referral device 5494.

When the reject referral device 5492 is activated, the client management software program 5100 preferably sends a referral rejection notification 5496 to the service provider computer 2100 of the referring service provider. Further when the reject referral device 5492 is activated, the client management software program 5100 preferably establishes in the client referral record an indication that the referral was rejected, such that the client referral status indicator 5488 will indicate that the client referral has been rejected.

When the accept referral device 5494 is activated, the client management software program 5100 preferably sends a referral acceptance notification 5498 to the service provider computer 2100 of the referring service provider. Further when the accept referral device 5494 is activated, the client management software program 5100 preferably establishes in the client referral record an indication that the referral was accepted, such that the client referral status indicator 5488 will indicate that the client referral has been accepted.

Referring again to FIG. 39, further when the accept referral device 5494 is activated, the client management software program 5100 preferably sends a referral acceptance message 5560 to the client using the client message address identifier 5136. Preferably, the referral acceptance message 5560 includes at least one referral acceptance message component 5570. Preferably, the at least one referral acceptance message component 5570 includes one or more of the following: (1) a referral purpose explanation 5574 (for example, an explanation as to the purpose of the referral acceptance message 5560), (2) a referral service provider name 5578 (for example, the name of the referral service provider that will be conducting the referral encounter), (3) a referral service provider location 5582 (for example, the location at which the referral encounter is to take place), (4) a referral encounter description 5584 (for example, a description of the referral encounter agenda), and (5) a referral registration initiation device 5590 (for example, a hyperlink).

When activated, the referral registration initiation device 5590 preferably sends to the client registration software program 4100 on the service provider computer 2100 of the referral service provider a registration initiation request 5200. The registration initiation request 5200 preferably includes at least one registration initiation parameter 5210. Preferably, the at least one registration initiation parameter 5210 includes one or more of the following: (1) the service provider name identifier 5124, and (2) the service provider location identifier 5126.

Registration of the client preferably continues as indicated previously, however, preferably, the new registration form data (that is, the registration form data going into the registration form associated with the referral service provider) preferably is filled in (for example, auto-populated, pre-populated, and/or mapped) with any duplicate information from (and/or information determinable based on and/or using information from) the initial registration form data (that is, the registration form data that went into the registration form associated with the referring service provider).

### DEFINITIONS

The following definitions are provided for the following terms as examples only and are not intended to limit the meaning of any term.

“Hyper Text Markup Language” or “HTML” is the predominant markup language for web pages. A markup language is a set of markup tags, and HTML uses markup tags to describe web pages. HTML elements form the building blocks of all websites. HTML allows images and objects to be embedded and can be used to create interactive forms. It provides a means to create structured documents by denoting structural semantics for text such as headings, paragraphs, lists, links, quotes, and other items. It can embed scripts in languages, such as JavaScript, which affect the behavior of HTML web pages. HTML can also be used to include Cascading Style Sheets (CSS) to define the appearance and layout of text and other material. The W3C, maintainer of both HTML and CSS standards, encourages the use of CSS over explicit presentational markup.

“Cascading Style Sheets” or “CSS” define the appearance and layout of text and other material.

“Encryption” is the process of transforming information (referred to sometimes as plaintext) using an algorithm (called cipher) to make it unreadable to anyone except those possessing special knowledge, usually referred to as a key. The result of the process is encrypted information (in cryptography, referred to as cipher text). In many contexts, the word “encryption” also implicitly refers to the reverse process, decryption (for example, “software for encryption” can typically also perform decryption), to make the encrypted information readable again (that is, to make it unencrypted).

An “Application Programming Interface” or “API” is an interface implemented by a software program that enables it to interact with other software. It facilitates interaction between different software programs similar to the way the user interface facilitates interaction between humans and computers. An API is implemented by applications, libraries, and operating systems to determine their vocabularies and calling conventions, and is used to access their services. It may include specifications for routines, data structures, object classes, and protocols used to communicate between the consumer and the implementer of the API.

A “Library” is a collection of subroutines or classes used to develop software. Libraries contain code and data that provide services to independent programs. This allows the sharing and changing of code and data in a modular fashion. Some executables are both standalone programs and libraries, but most libraries are not executable. Executables and libraries make references known as “links” to each other through the process known as linking, which is typically done by a linker. Most modern software systems provide libraries that implement the majority of system services. Such libraries have commoditized the services that a modern application requires. As such, most code used by modern applications is provided in these system libraries.

“Drag-and-Drop” is the action of (and/or support for the action of) selecting a virtual object, dragging it to a different location or onto another virtual object, and releasing it. In general, it can be used to invoke many kinds of actions, or create various types of associations between two abstract objects. As a feature, support for drag-and-drop is not found in all software, though it is sometimes a fast and easy-to-learn technique for users to perform tasks. However, the lack of affordances in drag-and-drop implementations means that it is not always obvious that an item can be dragged.

“PDF” or “Portable Document Format” is an open standard for document exchange. Each PDF file encapsulates a complete description of a fixed-layout 2D document that includes the text, fonts, images, and 2D vector graphics that compose the documents. Embedded objects can also be included in the document.

“EMR” or “Electronic Medical Record” (both can be synonymous with “EHR” or “Electronic Health Record”) is a record in digital format that is capable of being shared across different health care settings, by being embedded in network-connected enterprise-wide information systems. Such records may include a whole range of data in comprehensive or summary form, including demographics, medical history, medication and allergies, immunization status, laboratory test results, radiology images, vital signs, personal stats like age and weight, and billing information. EMR systems are computer systems that store, process, and otherwise manipulate such records.

“PHR” or “Personal Health Record” is typically a health record that is initiated and maintained by an individual. An ideal PHR would provide a complete and accurate summary of the health and medical history of an individual by gathering data from many sources and making this information accessible online to anyone who has the necessary electronic credentials to view the information. PHR systems are computer systems that store, process, and otherwise manipulate such records.

“PMS” or “Patient Management System” is a computer system that stores, processes, and otherwise manipulates data related to patient relationships and interaction with health care providers. Examples include, but are not limited to, Vista, and CPRS (Computer Patient Record System), both of which are used by the United States federal government.

“HCP” is synonymous with “Healthcare Provider”.

“Staff User” is a staff member of the HCP or can be the HCP.

“Client Facing Information” is information collected from a client, about a client, and/or entered by a client from a multitude of interface options.

“Doctor-Client Relationship” refers to a bona fide “doctor-client relationship” that must be established between an individual and a physician before any duty of confidentiality is created. Generally speaking, individuals must voluntarily seek advice or treatment from the doctor, and have an expectation that the communication will be held in confidence. This expectation of confidentiality does not need to be expressed. It is implied from the circumstances.

“SAAS” or “Software As A Service” or “software on demand” is software that is deployed over the Internet (and/or other network) and/or is deployed to run behind a firewall (and/or other security barrier) on a local area network (and/or other network) or computer. With SAAS, a provider licenses an application to customers either as a service on demand, through a subscription, in a “pay-as-you-go” model, or at no charge. This approach to application delivery is part of the utility computing model where all of the technology is in the “cloud” accessed over the Internet (and/or other network) as a service.

“Medical Coding Types” are numbers or alphanumeric codes used by the medical professional community to identify specific health terms, encounters, procedures, lab results, and drugs.

“CPT-4”—Current Procedural Terminology (CPT) was created by the American Medical Association (AMA) and is used for billing procedure codes in the USA (for example, 99214=Level 4 Established Client Office Visit). CPT-4 is required for 2010/2012 Stage 1 Meaningful Use compliance criteria for interoperability.

“ICD-9-CM” (USA), changing to “ICD-10-CM” (USA), was created by the World Health Organization (WHO) and is used for the classification of medical diseases and problems for billing purposes, worldwide (for example, 250.01=“Diabetes mellitus without mention of complication, type I (juvenile type), not stated as uncontrolled”; and, for example, ICD-10 codes M25.5 for “Pain in joint” or R06.2 for “Wheezing”). It is required for 2010/2012 Stage 1 Meaningful Use compliance criteria for interoperability.

“SNOMED-CT” (USA) or “Systematized Nomenclature of Medicine—Clinical Terms” was created by the International Health Terminology Standards Development Organization (IHTSDO) and is multi-axial reference terminology for the sharing and research of clinical findings across systems, in various domains, chiefly diseases, procedures, and microorganisms (for example, 46635009=Diabetes mellitus type 1 disorder). It is required for 2010/2012 Stage 1 Meaningful Use compliance criteria for interoperability.

“RxNorm” was created by the National Library of Medicine (NLM) and is multi-level drug and drug delivery device terminology that includes a variety of conceptual levels, including generic ingredient, and semantic branded drug form (for example, SCD: 389171=Omeprazole 10 MG Oral Tablet). It is required for 2010/2012 Stage 1 Meaningful Use compliance criteria for interoperability.

“LOINC” or “Logical Observation Identifiers Names and Codes” was created by Regenstrief Institute, and is terminology for laboratory and other clinical observations, including: chemistry, hematology, microbiology, toxicology, vital signs, radiology, gastroendoscopic procedures, pulmonary ventilator management, etc. (for example, 57021-8=CBC W Auto Differential panel:-:Pt:Bld:Qn:).

“HCPCS” or “Healthcare Common Procedure Coding System” was created by the Centers for Medicare and Medicaid Services (CMS) and is an extension of CPT, used for billing of non-physician services, prosthetics, and supplies (for example, A4565=Arm sling).

“DSM-IV” or “Diagnostic and Statistical Manual of Mental Disorders” was created by the American Psychiatric Association (APA) and is multi-axial classification and coding terminology for mental disorders (for example, 296.80=Bipolar disorder, without full episodic recovery).

“UNII” or “Unique Ingredient Identifier” was created by the Food and Drug Administration (FDA) and is a listing of unique drug and food ingredients, primarily for the purpose of identifying existing and potential allergens. It is imported into RxNorm (for example, Q42T66VG0C=Penicillin G).

“MEDCIN” or “Medical Computerized International Nomenclature” contains over 278,000 clinical concepts designed for use at the point-of-care. It is sometimes called an “interface terminology”. MEDCIN concepts encompass symptoms, history, physical examination, tests, diagnoses, and therapy. The MEDCIN knowledgebase includes over 68 million “relevancy links” to produce relevant clinical concepts at the point of care, even in the absence of templates. MEDCIN is cross-mapped to standard reference terminologies, including CPT-4, ICD-9-CM, SNOMED-CT, LOINC, DSM-IV, RxNorm, UNII, CVX (which identifies the type of vaccine used, if applicable), and CCC.

“CCR” or “Continuity of Care Record” is a health record standard specification developed jointly by the American Society for Testing and Materials (ASTM), the Massachusetts Medical Society (MMS), the Healthcare Information and Management Systems Society (HIMSS), the American Academy of Family Physicians (AAFP), the American Academy of Pediatrics (AAP), and other health informatics vendors. The CCR standard is a client health summary standard. It is a way to create flexible documents that contain the most relevant and timely core health information about a client (for example, patient), and to send those electronically from one caregiver to another. It contains various sections such as client (for example, patient) demographics, insurance information, diagnosis and problem list, medications, allergies, and care plans. These represent a “snapshot” of a client's (for example, patient's) health data that can be useful or possibly lifesaving, if available at the time of a clinical encounter. The ASTM CCR standard is designed to permit easy creation by a physician using an electronic health record (EHR) system at the end of an encounter. Google Health is an example of a personal health record (PHR) service that uses the CCR Standard. Microsoft's HealthVault, Dossia, and the open-source Indivo project also use the CCR Standard. Because it is expressed in the standard data interchange language known as XML, a CCR can potentially be created, read, and interpreted by any EHR or EMR software application. A CCR can also be exported in other formats, such as PDF and Office Open XML (Microsoft Word 2007 format).

“CDA” (the HL7 Clinical Document Architecture) is an XML-based markup standard intended to specify the encoding, structure, and semantics of clinical documents for exchange. CDA is part of the HL7 version 3 standard. Akin to other parts of the HL7 version 3 standard, it was developed using the HL7 Development Framework (HDF) and it is based on the HL7 Reference Information Model (RIM) and the HL7 Version 3 Data Types. CDA documents are persistent in nature. The CDA specifies that the content of the document consist of a mandatory textual part (which ensures human interpretation of the document contents) and optional structured parts (for software processing). The structured part relies on coding systems (such as from SNOMED and LOINC, for example) to represent concepts.

“CCD” or “Continuity of Care Document” is an HL7 CDA implementation of the Continuity of Care Record (CCR) and is not a competing standard.

“HIPAA” is the Health Insurance Portability and Accountability Act of 1996, Public Law 104-191, which was enacted on Aug. 21, 1996.

“American Recovery and Reinvestment Act of 2009”, abbreviated ARRA and commonly referred to as “The Stimulus” or The “Recovery Act”, is an economic stimulus package enacted by the 111th United States Congress in February 2009.

“Meaningful Use” refers to the meaningful use of EHRs intended by the U.S. government incentives and is categorized as follows: (1) Improve care coordination, (2) Reduce healthcare disparities, (3) Engage clients and their families, (4) Improve population and public health, and (5) Ensure adequate privacy and security. Incentives to providers who use information technology (IT) include: (1) Strict and open standards (to ensure users and sellers of EHRs work towards the same goal); and (2) Certification of software (to provide assurance that the EHRs meet basic quality, safety, and efficiency standards). The detailed definition of “meaningful use” is to be rolled out in 3 stages over a period of time until 2015. Details of each stage are hotly debated by various groups. Only stage 1 has been defined while the remaining stages will evolve over time.

Meaningful use EHR requirement criteria—these are 25 Objectives established by the Centers for Medicare and Medicaid Services (CMS). (The present invention assists health care providers in meeting at least 16 of these 25 Objectives (see below), especially with regard to the present invention's registration functionality and reminders functionality.)

Objective #3: Maintain an up-to-date problem list of current and active diagnoses based on ICD-9-CM or SNOMED CT. Measure: At least 80 percent of all unique clients seen by the HCP have at least one entry or an indication of none recorded as structured data.

Objective #5: Maintain an active medication list. Measure: At least 80 percent of all unique clients seen by the HCP have at least one entry (or an indication of “none” if the client is not currently prescribed any medication) recorded as structured data.

Objective #6: Maintain an active medication allergy list. Measure: At least 80 percent of all unique clients seen by the HCP have at least one entry (or an indication of “none” if the client has no medication allergies) recorded as structured data.

Objective #7: Record demographics. Measure: At least 80 percent of all unique clients seen by the HCP or admitted to the eligible hospital have demographics recorded as structured data.

Objective #9: Record smoking status for clients 13 years old or older. Measure: At least 80 percent of all unique clients 13 years old or older seen by the HCP have a “smoking status” recorded.

Objective #10: Incorporate clinical lab-test results into EHR as structured data. Measure: At least 50 percent of all clinical lab tests results ordered by the HCP or by an authorized provider of the eligible hospital during the EHR reporting period whose results are in either.

Objective #13: Send reminders to clients per client preference for preventive/follow-up care. Measure: Reminder sent to at least 50 percent of all unique clients seen by the HCP that are 50 and over.

Objective #14: Implement five clinical decision support rules relevant to specialty or high clinical priority, including for diagnostic test ordering, along with the ability to track compliance with those rules. Measure: Implement five clinical decision support rules relevant to the clinical quality metrics the HCP is responsible for as described further in section II.A.3.

Objective #15: Check insurance eligibility electronically from public and private payers. Measure: Insurance eligibility checked electronically for at least 80 percent of all unique clients seen by the HCP.

Objective #17: Provide clients with an electronic copy of their health information (including diagnostic test results, problem list, medication lists, and allergies) upon request. Measure: At least 80 percent of all clients who request an electronic copy of their health information are provided it within 48 hours.

Objective #18: Provide clients with timely electronic access to their health information (including lab results, problem list, medication lists, and allergies). Measure: At least 10 percent of all unique clients seen by the HCP are provided timely electronic access to their health information.

Objective #19: Provide clinical summaries to clients for each office visit. Measure: Clinical summaries provided to clients for at least 80 percent of all office visits.

Objective #20: Capability to exchange key clinical information (for example, problem list, medication list, allergies, and diagnostic test results) among providers of care and client authorized entities electronically. Measure: Perform at least one test of certified EHR technology's capacity to electronically exchange key clinical information.

Objective #21: Perform medication reconciliation at relevant encounters and each transition of care. Measure: Perform medication reconciliation for at least 80 percent of relevant encounters and transitions of care.

Objective #22: Provide summary care record for each transition of care and referral. Measure: Provide summary of care record for at least 80 percent of transitions of care and referrals.

Objective #25: Protect electronic health information maintained using certified EHR technology through the implementation of appropriate technical capabilities. Measure: Conduct or review a security risk analysis in accordance with the requirements under 45 CFR 164.308 (a)(1) and implement security updates as necessary.

What is claimed is:

1. A computer system comprising:
a host server, the host server having a processor unit, a memory unit, a storage unit, an input device, an output device, and a network interface;
a database stored on the storage unit, the database including a client data form field library, a client data form block library, a client data form page library, and a client data form library; and
a client data form authoring program stored on the storage unit and executable by the processor unit with access to the memory unit;
wherein the client data form authoring program during execution receives a plurality of client data form field library values and stores the plurality of client data form field library values in the client data form field library such that the client data form field library defines a plurality of client data form fields;
wherein the client data form authoring program during execution receives a plurality of client data form block library values and stores the plurality of client data form block library values in the client data form block library such that the client data form block library defines a plurality of client data form blocks, each client data form block being defined by a selection and an arrangement of a plurality of the plurality of client data form fields;
wherein the client data form authoring program during execution receives a plurality of client data form page library values and stores the plurality of client data form page library values in the client data form page library such that the client data page form library defines a plurality of client data form pages, each client data form page being defined by a selection and an arrangement of a plurality of the plurality of client data form blocks; and
wherein the client data form authoring program during execution receives a plurality of client data form library values and stores the plurality of client data form library values in the client data form library such that the client data form library defines a plurality of client data forms, each client data form being defined by a selection and an arrangement of a plurality of the plurality of client data form pages, and associates each client data form with at least one service provider.

2. The computer system of claim 1, wherein the client data form field library includes a plurality of client data form field records, each having a plurality of client data form field configuration parameter records, and the plurality of client data form field library values includes a plurality of client data form field configuration parameter values, each being stored in a respective one of the client data form field configuration parameter records.

3. The computer system of claim 2, wherein each of the client data field configuration parameter records is associated with a respective one of the following client data field configuration parameters: label, font face, font size, color, mask, language, field count, text description, numerical value, coded value, logic formula, mapping, and type.

4. The computer system of claim 3, wherein the coded value is a clinical nomenclature code selected from the group consisting of MEDCIN, SNOMED, RxNorm, ICD-9, ICD-10, CPT-4, LOINC, HCPCS, DSM-IV, and UNII.

5. The computer system of claim 1, wherein the client data form authoring program during execution presents a client data form authoring program user interface that features a drag and drop interface, such that at least one of the client data form field library values, the client data form block library values, the client data form page library values, and the client data form library values is established by at least one activation of the drag and drop interface.

6. The computer system of claim 5, wherein the client data form authoring program during execution presents a client data form authoring program user interface that features an anatomical diagrammatic depiction selection interface, such that at least one of the client data form field library values, the client data form block library values, the client data form page library values, and the client data form library values is established by at least one activation of the anatomical diagrammatic depiction selection interface.

7. A computer system comprising:
a host server, the host server having a processor unit, a memory unit, a storage unit, an input device, an output device, and a network interface;
a database stored on the storage unit, the database including a client data form field library, a client data form block library, a client data form page library, and a client data form library; and
a client registration program stored on the storage unit and executable by the processor unit;
wherein the client data form field library defines a plurality of client data form fields;
wherein the client data form block library defines a plurality of client data form blocks, each client data form block being defined by a selection and an arrangement of a plurality of the plurality of client data form fields;
wherein the client data form page library defines a plurality of client data form pages, each client data form page being defined by a selection and an arrangement of a plurality of the plurality of client data form blocks;
wherein the client data form library defines a plurality of client data forms, each client data form being defined by a selection and an arrangement of a plurality of the plurality of client data form pages, and associates each client data form with at least one service provider;
wherein the client registration program during execution receives a client registration initiation request that includes at least one client registration initiation parameter, the at least one client registration initiation parameter including an identifier that identifies one of the at least one service provider;
wherein the client registration program during execution uses the identifier to select one of the plurality of client data forms, the selected client data form being associated with the identified service provider; and
wherein the client registration program during execution presents the selected client data form in accordance with the client data form page selection and arrangement for the selected client data form, the client data form block selection and arrangement for each selected client data form page, and the client data form field selection and arrangement for each selected client data form block.

8. The computer system of claim 7,
wherein the client data form field library includes a plurality of client data form field records, each including a plurality of client data form field configuration parameter records;
wherein the client data form block library includes a plurality of client data form block records, each including a plurality of client data form field reference records and a client data form field arrangement record, each client data form field reference record referencing a respective one of the client data form field records, the client data form field arrangement record defining a client data form field arrangement;
wherein the client data form page library includes a plurality of client data form page records, each including a plurality of client data form block reference records and a client data form block arrangement record, each client data form block reference record referencing a respective one of the client data form block records, the client data form block arrangement record defining a client data form block arrangement;
wherein the client data form library includes a plurality of client data form records, each including a plurality of client data form page reference records, a client data form page arrangement records, and at least one service provider association record, each client data form page reference record referencing a respective one of the client data form page records, the client data form page arrangement record defining a client data form page arrangement; and
wherein the client registration program during execution presents the selected client data form by:
determining, for the selected client data form, the client data form page selection from the client data form page reference records of the client data form record associated with the selected client data form, and determining, for the selected client data form, the client data form page arrangement from the client data form page arrangement record of the client data form record associated with the selected client data form;
determining, for each selected client data form page, the client data form block selection from the client data form block reference records of the client data form page record associated with the selected client data form page, and determining, for each selected client data form page, the client data form block arrangement from the client data form block arrangement record of the client data form page record associated with the selected client data form page;
determining, for each selected client data form block, the client data form field selection from the client data form field reference records of the client data form block record associated with the selected client data form block, and determining, for each selected client data form block, the client data form field arrangement from the client data form field arrangement record of the client data form block record associated with the selected client data form block; and
arranging the selected client data form fields within the selected client data form blocks in accordance with the client data form field arrangement, arranging the selected client data form blocks within the selected data form pages in accordance with the client data form block arrangement, and arranging the selected client data form pages in accordance with the client data form page arrangement.

9. The computer system of claim 7, wherein the client registration program during execution in connection with the presentation of the selected client data form receives client registration form data and stores the client registration form data and a form record identifier in a client record in a client library in the database, the form record identifying the selected client data form.

10. The computer system of claim 9, wherein the client registration program during execution in connection with the receipt of the client registration form data presents at least one client authorization document including at least one client authorization field, and receives client authorization field data, the at least one client authorization document being selected from the group consisting of an authorization for use and disclosure of protected health information form, an insurance assignment and authorization to release information form, and a HIPAA notice of privacy practices form.

11. The computer system of claim 9, wherein the client registration program during execution in connection with the storing of the client registration form data presents a portable document format generation initiation device and receives an indication of an activation of the portable document format generation initiation device, and in response to the indication of the activation of the portable document format generation initiation device, retrieves from the client record portable document format generation instructions, and generates a completed portable document format form using the portable document format generation instructions, the selected client data form, and the client registration form data.

12. A computer system comprising:
a host server, the host server having a processor unit, a memory unit, a storage unit, an input device, an output device, and a network interface;
a database stored on the storage unit, the database including a client data form field library, a client data form block library, a client data form page library, a client data form library, and a client library; and
a client management program stored on the storage unit and executable by the processor unit;
wherein the client data form field library defines a plurality of client data form fields;
wherein the client data form block library defines a plurality of client data form blocks, each client data form block being defined by a selection and an arrangement of a plurality of the plurality of client data form fields;
wherein the client data form page library defines a plurality of client data form pages, each client data form page being defined by a selection and an arrangement of a plurality of the plurality of client data form blocks;
wherein the client data form library defines a plurality of client data forms, each client data form being defined by a selection and an arrangement of a plurality of the plurality of client data form pages, and associates each client data form with at least one service provider;
wherein the client library includes a plurality of client records, each client record including respective client registration form data and a respective form record identifier, the form record identifier identifying a respective one of the plurality of client data forms; and
wherein the client management program during execution receives a client registration retrieval request that includes a requesting service provider identifier, and in response to the client registration retrieval request accesses the client library, uses the requesting service provider identifier to select at least one of the client records, retrieve from the selected client record the respective form identifier of the selected client record, and present a client registration listing that includes the retrieved respective form record identifier.

13. The computer system of claim 12, wherein the client management program during execution retrieves from the selected client record the client registration form data of the selected client record, and uses the form record identifier of the selected client record to associate with the retrieved client registration form data one of the plurality of client data forms.

14. The computer system of claim 13, wherein the client management program during execution presents a portable document format generation initiation device and receives an indication of an activation of the portable document format generation initiation device, and in response to the indication of the activation of the portable document format generation initiation device, retrieves from the selected client record portable document format generation instructions, and generates a completed portable document format form using the portable document format generation instructions, the associated client data form, and the retrieved client registration form data.

15. The computer system of claim 13, wherein the client management program during execution presents a specialized format generation initiation device and receives an indication of an activation of the specialized format generation initiation device, and in response to the indication of the activation of the specialized format generation initiation device, retrieves specialized format generation instructions, generates a completed specialized format of the retrieved client registration form data using the specialized format generation instructions, the associated client data form, and the retrieved client registration form data.

16. The computer system of claim 15, wherein the specialized format is a format selected from the group consisting of Application Programming Interface, Health Level Seven International, Comma Separated Values, Extensible Markup Language, Continuity of Care Document, and Continuity of Care Record.

17. The computer system of claim 12, wherein the client management program during execution presents, in association with the selected client record, a refer client initiation device, receives an indication of an activation of the refer client initiation device, receives refer client parameter data including a referral service provider correspondence address, and sends to the referral service provider correspondence address a client referral message related to the selected client record.

18. The computer system of claim 16, wherein the at least one service provider is at least one of a plurality of service providers, and each of the plurality of service providers is associated with at least one of the plurality of client data forms in the client data form library, and wherein when the referral service provider correspondence address is a correspondence address for a service provider who is not one of the plurality of service providers, the client referral message includes a subscription initiation device, and wherein the client management program during execution receives an indication of an activation of the subscription initiation device, and in response to the indication of the activation of the subscription initiation device, initiates a service provider subscription process.

19. The computer system of claim 16, wherein the at least one service provider is at least one of a plurality of service providers, and each of the plurality of service providers is associated with at least one of the plurality of client data forms in the client data form library, and wherein when the referral service provider correspondence address is a correspondence address for a service provider who is one of the plurality of service providers, the client referral message includes a client referral management initiation device, and wherein the client management program during execution receives an indication of an activation of the client referral management initiation device, and in response to the indication of the activation of the client referral management initiation device, presents a client referral listing that includes data associated with the selected client record.

20. The computer system of claim 19, wherein the client management program during execution presents, in association with the client referral listing, a client referral status indicator and a client referral disposition initiation device, and during execution receives an indication of an activation of the client referral disposition initiation device, and in response to the indication of the activation of the client referral disposition initiation device, sends a client referral disposition message, and establishes in the selected client record a client referral disposition indication.
